(19) United States
(12) Patent Application Publication
(10) Pub. No.: US 2013/0183889 A1
(43) Pub. Date: Jul. 18, 2013

(54) PROCESS FOR PRODUCING POLISHING LIQUID COMPOSITION

(71) Applicants: Yasuhiro Yoneda, Wakayama (JP); Koji Taira, Wakayama (JP); Kanji Sato, Wakayama (JP); Yoshiaki Oshima, Wakayama (JP)

(72) Inventors: Yasuhiro Yoneda, Wakayama (JP); Koji Taira, Wakayama (JP); Kanji Sato, Wakayama (JP); Yoshiaki Oshima, Wakayama (JP)

(73) Assignee: KAO CORPORATION, Tokyo (JP)

(21) Appl. No.: 13/824,235

(22) PCT Filed: Sep. 21, 2011
(86) PCT No.: PCT/JP2011/071501

§ 371 Date: Mar. 15, 2013

(30) Foreign Application Priority Data
Sep. 24, 2010 (JP) 2010-214083
Jan. 7, 2011 (JP) 2011-002537
Sep. 15, 2011 (JP) 2011-202262

(51) Int. Cl. C09G 1/02; B24B 37/04

(52) U.S. Cl. CPC C09G 1/02; B24B 37/044
USPC 451/59; 252/79.1; 51/308

(57) ABSTRACT

Provided is a process for producing a polishing liquid composition with which it is possible to give a polished work that has a reduced surface roughness and a reduced amount of particles. The process for producing a polishing liquid composition involves a step in which a raw silica dispersion containing colloidal silica having an average primary-particle diameter of 1-100 nm is filtered through a filter including a filter aid, the filter aid having an average pore diameter, as measured by the mercury intrusion method, of 0.1-3.5 μm.

### TECHNICAL FIELD

The present invention relates to a process for producing a polishing liquid composition and a polishing liquid composition produced by the production process.

### BACKGROUND ART

In recent years, there is a demand for high capacity and reduction in a diameter in memory hard disk drives, and in order to increase recording density, there is a request that a unit recording area be reduced by decreasing a floating amount of a magnetic head. Along with this, requirement for surface quality after polishing is becoming strict year after year also in the step of producing a magnetic disk substrate. That is, it is necessary to reduce surface roughness, minute warpage, roll-off, and protrusions in accordance with reduction in a floating amount of a head, and the allowable number of scratches per substrate surface and the allowable size and depth thereof are decreasing along with the reduction in a unit recording area.

Further, integration and speed are increasing also in a semiconductor field, and particularly in high integration, there is a demand that wiring be finer. Consequently, in a process for producing a semiconductor substrate, depth of focus becomes small at a time of exposing a photoresist to light, and hence, further surface smoothness is desired.

In order to reduce scratches formed on a surface of a polished work for the purpose of improving surface smoothness in response to the above-mentioned request, there has been proposed that the number of course particles in polishing particles be reduced by centrifugation of an abrasive slurry material and circulating filtration and multistage filtration using a depth filter and a pleats filter (Patent Documents 1 and 2).

Further, a filter using diatomaceous earth as a filter aid is used as a filter for a polishing liquid composition to be used for circulating polishing of a glass substrate (Patent Document 3) and used in a production step of a silica fine particle dispersion to be used as an inkjet recording sheet coating solution (Patent Document 4).

### PRIOR ART DOCUMENTS

### Patent Documents

Patent document 1: JP 2006-075975 Å
Patent document 2: JP 2006-136996 Å
Patent document 3: JP 2007-098485 Å
Patent document 4: JP 2007-099586 Å

### DISCLOSURE OF INVENTION

### Problem to be Solved by the Invention

In order to achieve high density such as high capacity and high integration, it is necessary to reduce particles on a substrate surface as well as scratches on the substrate surface. Therefore, it is necessary to reduce course particles in silica particles to be used for a polishing liquid composition, and hence, the silica particles are often prepared in a filtering system shown in a schematic view of FIG. 2. Specifically, silica particles for a polishing liquid composition are prepared by a filtering system that involves subjecting a silica slurry 6, which is obtained by subjecting general-purpose colloidal silica to centrifugation or the like, to circulating filtration by a depth filter 3 (tank 1→pipe P1→depth filter 3→pipe P5→tank 1), and filtering the resultant silica slurry 6 by a pleats filter 5 (depth filter 3→pipe P6→pleats filter 5→pipe 4). However, according to such a conventional method, it takes time and cost for a treatment (for example, centrifugation) before filtering of the general-purpose colloidal silica, and it also takes time for circulating filtration by the depth filter. That is, in the step of preparing silica particles to be used for a polishing liquid composition, time for producing a polishing liquid composition is long, which is one factor for high cost.

Accordingly, the present invention provides a process for producing a polishing liquid composition capable of economically producing a polishing liquid composition in which surface roughness of polished work is small and particles to be important in an increase in density can be reduced effectively, and a polishing liquid composition produced by the production process.

### Means for Solving Problem

More specifically, the present invention relates to a process for producing a polishing liquid composition (hereinafter, sometimes referred to as “production process of the present invention”) including the step of filtering a raw silica dispersion containing colloidal silica having an average primary-particle diameter of 1 to 100 nm with a filter including a filter aid, wherein an average pore diameter of the filter aid, as measured by a mercury intrusion method, is 0.1 to 3.5 μm.

Further, the present invention relates to a polishing liquid composition (hereinafter, sometimes referred to as “polishing liquid composition of the present invention”) that can be produced by a process for producing a polishing liquid composition including the step of filtering a raw silica dispersion containing colloidal silica having an average primary-particle diameter of 1 to 100 nm with a filter including a filter aid, wherein an average pore diameter of the filter aid, as measured by a mercury intrusion method, is 0.1 to 3.5 μm.

### Effects of the Invention

According to the production process of the present invention, due to the step of filtering through use of a filter including a filter aid, coarse particles and sediment in a silica dispersion can be removed effectively, and in a polishing liquid composition containing the filtered silica dispersion, scratches and particles at a time of polishing can be reduced effectively. Further, according to the production process of the present invention, a silica dispersion from which coarse particles and sediment have been removed efficiently can be obtained without performing a treatment (for example, centrifugation) with respect to general-purpose colloidal silica before filtration and circulating filtration, and hence, load on facilities, production time of a polishing liquid composition, and cost can be reduced.

Accordingly, when the polishing liquid composition produced by the production process of the present invention is used, for example, in the step of polishing a precision component substrate for high density or high integration, a precision component substrate can be produced economically, such as a memory hard disk substrate and a semiconductor element substrate of high quality in which minute scratches and particles can be reduced effectively and surface properties are excellent.

### BRIEF DESCRIPTION OF DRAWINGS

FIG. 1 is a schematic view illustrating one embodiment of a production process of the present invention.

FIG. 2 is a schematic view illustrating an example of a conventional process for producing a polishing liquid composition.

### DESCRIPTION OF THE INVENTION

A process for producing a polishing liquid composition of the present invention includes the step of filtering a raw silica dispersion containing colloidal silica having an average primary-particle diameter of 1 to 100 nm with a filter including a filter aid (hereinafter, sometimes referred to as “filter aid-including filter”), wherein the filter aid has an average pore diameter, as measured by a mercury intrusion method, of 0.1 to 3.5 μm. The polishing liquid composition obtained by the production process of the present invention can provide a substrate in which particles on a substrate surface can be reduced effectively and which has excellent surface smoothness.

The inventors of the present invention found that sediment in a polishing liquid composition causes particles. The reason why a polishing liquid composition capable of reducing particles on a polished substrate surface can be produced economically by the production process of the present invention is not clear. However, it is presumed that sediment causing particles is removed efficiently through between particles of tens of μm formed of a filter aid, a submicron gap of a secondary aggregate, submicron small holes in filter aid particles in a filter aid layer (cake layer) of a filter including a filter aid.

The term “coarse particle” as used herein refers to a coarse colloidal silica particle having a particle diameter of 0.5 μm or more, and the number of coarse particles in the polishing liquid composition can be quantitatively evaluated as coarse particles in the polishing liquid composition based on a 0.45 μm filter liquid passing quantity in examples described later. In the present specification, the colloidal silica particles in the polishing liquid composition include not only primary particles but also aggregated particles in which the primary particles fluocculate. Further, the term “sediment” as used herein refers to a silica aggregate of 50 to 500 nm, and the amount of sediment can be evaluated indirectly by ΔCV or polishing evaluation described later.

The term “scratch” as used herein refers to a physical property to be important for high density or high integration, particularly, in a memory hard disk substrate or a substrate for a semiconductor element, the scratch being a minute scar on a substrate surface having a depth of 1 nm or more and less than 100 nm, a width of 5 nm or more and less than 500 nm, and a length of 100 μm or more. The scratch can be detected with an optical surface analyzer (OSA6100, produced by KLA-Tencor) described in the examples described later, and can be quantitatively evaluated as the number of scratches. Further, the depth and width of a scratch can be measured with an atomic force microscope (AFM).

The term “particle” as used herein refers to a protrusion on a substrate and can be quantitatively evaluated as the number of particles by measurement with the optical surface analyzer (OSA6100, produced by KLA-Tencor) described in the examples described later. By analyzing a particle portion with a scanning electron microscope (SEM), a protrusion (silica, alumina, titanium, an Fe compound (stainless steel), an organic substance, a nickel compound (NiP polishing waste, nickel hydroxide, etc.)) can be identified. Further, a length and a width of the protrusion can be measured through use of the atomic force microscope (AFM).

Examples of a filter aid to be used in the production process of the present invention include insoluble mineral materials such as silicon dioxide, kaolin, Japanese acid clay, diatomaceous earth, pearlite, bentonite, and talc. Of the above-mentioned filter aids, silicon dioxide, diatomaceous earth, and pearlite are preferred, diatomaceous earth and pearlite are more preferred, diatomaceous earth is still more preferred, from the viewpoint of reducing scratches and particles.

It is preferred that the filter aid be pre-treated with acid, from the viewpoint of reducing scratches and particles and enhancing productivity of a polishing liquid composition. The pretreatment with acid refers to a treatment of soaking a filter aid in an acid aqueous solution of an inorganic acid or an organic acid for a predetermined period of time, and examples thereof include a treatment with hydrochloric acid, sulfuric acid, nitric acid, phosphoric acid, phosphonic acid, oxalic acid, and citric acid. The treatment with hydrochloric acid, sulfuric acid, nitric acid, phosphoric acid, and phospnoic acid is more preferred, and the treatment with hydrochloric acid, sulfuric acid, and phosphonic acid is more preferred, from the viewpoint of reducing scratches and particles.

From the viewpoint of reducing scratches and particles and enhancing productivity of a polishing liquid composition, an average pore diameter of the filter aid, as measured by a mercury intrusion method, is 0.1 to 3.5 μm, preferably 0.1 to 3.0 μm, more preferably 0.1 to 2.7 μm, still more preferably 1.0 to 2.7 μm, still further preferably 2.0 to 2.7 μm, still further preferably 2.1 to 2.7 μm, still further preferably 2.2 to 2.6 μm, still further preferably 2.2 to 2.4 μm. In the present invention, the term “average pore diameter, as measured by a mercury intrusion method” refers to an average value of a pore diameter based on a volume of a filter aid particle and can be measured by a method described in the examples.

An integrated pore volume of 0.5 μm or less of the filter aid, as measured by a mercury intrusion method, is preferably 2.5 mL/g or more, more preferably 2.7 mL/g or more, still more preferably 3.0 mL/g or more, still further preferably 4.0 mL/g or more, still further preferably 4.5 mL/g or more, from the viewpoint of reducing scratches and particles. Further, the integrated pore volume of 0.5 μm or less of the filter aid, as measured by a mercury intrusion method, is preferably 1,000 mL/g or less, more preferably 100 mL/g or less, still more preferably 50 mL/g or less, still further preferably 20 mL/g or less, still further preferably 10 mL/g or less, still further preferably 6 mL/g or less, from the viewpoint of enhancing productivity of the polishing liquid composition. Therefore, the integrated pore volume of 0.5 μm or less of the filter aid is preferably 2.5 mL/g or more, more preferably 2.5 to 1,000 mL/g or more, still more preferably 2.7 to 100 mL/g, still further preferably 3.0 to 50 mL/g, still further preferably 4.0 to 20 mL/g, still further preferably 4.5 to 10 mL/g, still further preferably 4.5 to 6 mL/g, from the viewpoint of reducing scratches and particles and from the viewpoint of enhancing productivity of the polishing liquid composition. Herein, the “integrated pore volume of 0.5 μm or less, as measured by a mercury intrusion method” of the filter aid refers to a total of pore volumes of 0.5 μm or less in a pore distribution of a volume standard of filter aid particles, as measured by a mercury intrusion method and can be measured by the method described in the examples.

A BET specific surface area of the filter aid is preferably 4.0 m²/g or more, more preferably 10.0 m²/g or more, still more preferably 15.0 m²/g or more, still further preferably 18.0 m²/g or more, from the viewpoint of reducing scratches and particles. Further, the specific surface area is preferably 1,000.0 m²/g or less, more preferably 100.0 m²/g or less, still more preferably 50.0 m²/g or less, still further preferably 30.0 m²/g or less, still further preferably 25.0 m²/g or less, from the viewpoint of enhancing productivity of the polishing liquid composition. Therefore, the specific surface area is preferably 4.0 to 1,000.0 m²/g, more preferably 10.0 to 100.0 m²/g, still more preferably 15.0 to 50.0 m²/g, still further preferably 15.0 to 30.0 m²/g, still further preferably 18.0 to 30.0 m²/g, still further preferably 18.0 to 25.0 m²/g. The BET specific surface area of the filter aid can be obtained by the method described in the examples.

An integrated pore volume of 0.15 μm or less by a nitrogen adsorption method of the filter aid is preferably 0.3 mL/g or more, more preferably 0.4 mL/g or more, still more preferably 0.6 mL/g or more, from the viewpoint of reducing scratches and particles. Further, the integrated pore volume is preferably 100.0 mL/g or less, more preferably 50.0 mL/g or less, still more preferably 10.0 mL/g or less, still further preferably 5.0 mL/g or less, still further preferably 2.0 mL/g or less, still further preferably 1.0 mL/g or less, still further preferably 0.7 mL/g or less, from the viewpoint of enhancing productivity of the polishing liquid composition. Therefore, the integrated pore volume is preferably 0.3 to 100.0 mL/g, more preferably 0.4 to 50.0 mL/g, still more preferably 0.6 to 10.0 mL/g, still further preferably 0.6 to 5.0 mL/g, still further preferably 0.6 to 2.0 mL/g, still further preferably 0.6 to 1.0 mL/g, still further preferably 0.6 to 0.7 mL/g. Herein, the integrated pore volume of 0.15 μm or less by the nitrogen adsorption method of the filter aid refers to a total of pore volumes of 0.15 μm or less in a pore distribution of a volume standard of the filter aid by the nitrogen adsorption method and can be obtained specifically by the method described in the examples.

A water permeability of the filter aid (hereinafter, sometimes referred to as “the filter aid permeability”) obtained by filtering water with the filter aid under a condition of 0.015 MPa is preferably 9.9×10⁻¹⁴ m² or less, more preferably 5.0×10⁻¹⁴ m² or less, still more preferably 3.0×10⁻¹⁴ m² or less, from the viewpoint of reducing scratches and particles. Further, the permeability is preferably 2.0×10⁻¹⁵ m² or more, more preferably 5.0×10⁻¹⁵ m² or more, still more preferably 9.9×10⁻¹⁵ m² or more, from the viewpoint of enhancing productivity of the polishing composition. Therefore, the permeability is preferably 2.0×10⁻¹⁵ to 9.9×10⁻¹⁴ m², more preferably 5.0×10⁻¹⁵ to 5.0×10⁻¹⁴ m², still more preferably 9.9×10⁻¹⁵ to 3.0×10⁻¹⁴ m². Herein, the filter aid permeability can be obtained specifically by the method described in the examples.

A laser average particle diameter of the filter aid is preferably 1 to 30 μm, more preferably 1 to 20 μm, still more preferably 1 to 18 μm, still further preferably 1 to 16 μm, still further preferably 2 to 16 μm, still further preferably 5 to 16 μm, still further preferably 7 to 16 μm, from the viewpoint of reducing scratched and particles. Herein the “laser average particle diameter” of the filter aid refers to an average particle diameter of filter aid particles measured by a laser type particle size distribution measurement apparatus and can be measured by the method described in the examples.

A filter aid-including filter to be used in the production process of the present invention is not particularly limited as long as it includes the filter aid on a surface of a filter and/or in the filter. A filter opening is preferably 1/10 or less, more preferably 1/20 or less, still more preferably 1/30 or less of an average particle diameter of a filter aid, from the viewpoint of reducing scratches and particles. In the production process of the present invention, body feeding further may be combined with precoating. The filter opening is preferably 10 μm or less, more preferably 5 μm or less, still more preferably 3 μm or less, still further preferably 2 μm or less, particularly preferably 1 μm or less, from the viewpoint of preventing leakage of the filter aid. Further, the filter opening is preferably 0.1 μm or more, more preferably 0.2 μm or more, still more preferably 0.3 μm or more, particularly preferably 0.5 μm or more, from the viewpoint of enhancing a filter liquid passing speed. Herein, the precoating refers to a method for forming a cake filtration filter, that is, forming a filter aid thin layer having a thickness of about several millimeters on a filter material (filter medium) described later. For example, there is a method for dispersing filter aid particles in water and filtering out a filter aid with a filter medium to form a filter aid layer. Further, the body feeding refers to a method for filtering an unfiltered solution to be subjected to cake filtration while pouring a predetermined amount of a filter aid to the unfiltered solution at a time of filtration, and a purpose of adding the filter aid is to improve filterability of the unfiltered solution. The body feeding is effective for an unfiltered solution whose cake resistance is immediately maximized (which becomes unable to be filtered) due to a minute particle diameter.

A content (g/cm²) of a filter aid in the filter aid-including filter is preferably 0.001 g/cm² or more, more preferably 0.005 g/cm² or more, still more preferably 0.01 g/cm² or more, still further preferably 0.02 g/cm² or more, still further preferably 0.04 g/cm² or more, still further preferably 0.1 g/cm² or more, from the viewpoint of reducing scratches and particles. Further, the content of a filter aid is preferably 1 g/cm² or less, more preferably 0.8 g/cm² or less, still more preferably 0.6 g/cm² or less, still further preferably 0.4 g/cm² or less, still further preferably 0.3 g/cm² or less, still further preferably 0.2 g/cm² or less, from the viewpoint of enhancing a filtration speed. Therefore, the content (g/cm²) of a filter aid is preferably 0.001 to 1 g/cm², more preferably 0.005 to 0.8 g/cm², still more preferably 0.01 to 0.6 g/cm², still further preferably 0.02 to 0.4 g/cm², still further preferably 0.04 to 0.3 g/cm², still further preferably 0.04 to 0.2 g/cm², and still further preferably 0.1 to 0.2 g/cm².

Examples of a filter material for the filter aid-including filter include plastic such as filter paper, polyethylene, polypropylene, polyether sulphone, cellulose acetate, nylon, polycarbonate, and Teflon (registered trademark); ceramic; and metal mesh. From the viewpoint of reducing scratches and particles, plastic such as filter paper, polyethylene, polypropylene, polyether sulphone, cellulose acetate, nylon, polycarbonate, and Teflon (registered trademark) is preferred; filter paper, polyethylene, polypropylene, polyether sulphone, cellulose acetate, and nylon are more preferred; and filter paper, polyethylene, and polypropylene are further preferred.

A shape of the filter aid-including filter is not particularly limited, and from the viewpoint of ease of handling and reduction of scratches and particles, a sheet type, a cylinder type, a disk type, and a folded type are preferred; a sheet type, a disk type, and a folded type are more preferred; and a disk type and a folded type are further preferred.

A condition for filtration through the filter aid-including filter is not particularly limited, and from the viewpoint of satisfying both enhancement of filtering precision and enhancement of productivity, a differential pressure at a time of filtration is preferably 0.01 to 10 MPa, more preferably 0.05 to 1 MPa, and still more preferably 0.05 to 0.5 MPa. The number of stages of the filter aid-including filter is preferably 1 to 5, more preferably 1 to 3, still more preferably 1 to 2, from the viewpoint of satisfying both enhancement of filtering precision and enhancement of productivity. A filtration speed is preferably 0.1 to 30 L/(min·m²), more preferably 0.5 to 25 L/(min·m²), still more preferably 1 to 20 L/(min·m²), from the viewpoint of satisfying both enhancement of filtering precision and enhancement of productivity.

According to the production process of the present invention, it is preferred to use a depth filter and a pleats filter by further combining them, which have been conventionally used for producing a polishing liquid composition, from the viewpoint of reducing scratches and particles.

As a preferred embodiment of the production process of the present invention, it is preferred that a raw silica dispersion be filtered with a depth filter and then with a filter aid-including filter, and it is more preferred that a raw silica dispersion be filtered with a filter aid-including filter and further with a pleats filter. It is presumed that, by removing particularly large coarse particles with a depth filter, excellent performance of the filter aid-including filter is exhibited remarkably, which enables efficient removal of coarse particles and sediment.

Thus, in another embodiment, the present invention relates to a process for producing a polishing liquid composition (hereinafter, sometimes referred to as a “production process (2) of the present invention”) including: a step 1) of filtering a raw silica dispersion containing colloidal silica having an average primary-particle diameter of 1 to 100 nm with a depth filter; and a step 2) of filtering the silica dispersion obtained in the step 1) with a filter including a filter aid having an average pore diameter, as measured by a mercury intrusion method, of 0.1 to 3.5 μm.

An amount of coarse particles having a particle diameter of 0.5 μm or more in the silica dispersion obtained by the filtration with the depth filter in the step 1 is preferably 11.0×10⁴ pieces/mL or less, more preferably 10.0×10⁴ pieces/mL or less, still more preferably 7.0×10⁴ pieces/mL or less, still further preferably 6.0×10⁴ pieces/mL or less, still further preferably 5.0×10⁴ pieces/mL or less, still further preferably 4.0×10⁴ pieces/mL or less, still further preferably 3.0×10⁴ pieces/mL or less, from the viewpoint of extending the life of the filter aid-including filter to be used in the step 2 and enhancing productivity.

Thus, in still another embodiment, the present invention relates to a process for producing a polishing liquid composition (hereinafter, sometimes referred to as “production process (3) of the present invention”) including: a step 1) of filtering a raw silica dispersion containing colloidal silica having an average primary-particle diameter of 1 to 100 nm so that an amount of coarse particles becomes 11.0×10⁴ pieces/mL or less; and a step 2) of filtering the silica dispersion obtained in the step 1 with a filter including a filter aid having an average pore diameter, as measured by a mercury intrusion method, of 0.1 to 3.5 μm.

The amount of coarse particles in the silica dispersion obtained in the filtration of the step 1 is preferably 11.0×10⁴ pieces/mL or less, more preferably 10.0×10⁴ pieces/mL or less, still more preferably 7.0×10⁴ pieces/mL or less, still further preferably 6.0×10⁴ pieces/mL or less, still further preferably 5.0×10⁴ pieces/mL or less, still further preferably 4.0×10⁴ pieces/mL or less, still further preferably 3.0×10⁴ pieces/mL or less, from the viewpoint of extending the life of the filter aid-including filter to be used in the step 2 and enhancing the productivity. Further, although the kind of the filtration in the step 1 is not limited, filtration using a depth filter is preferred, from the viewpoint of enhancing removal efficiency of coarse particles and lowering cost.

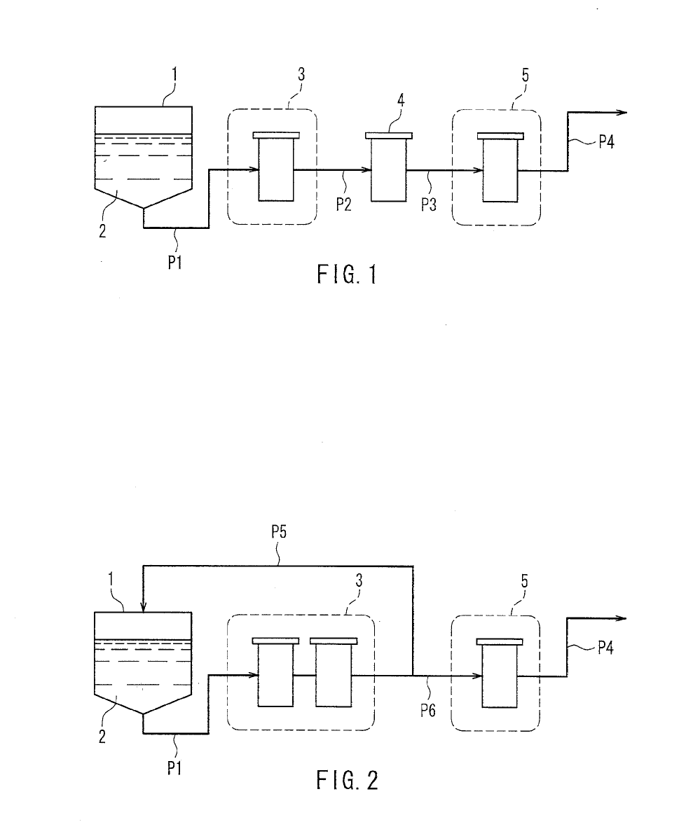

As an embodiment in which the production processes (2) and (3) of the present invention are not limited, there is an embodiment including steps shown in the schematic view of FIG. 1. FIG. 1 is a schematic view showing the steps of preparing silica particles to be used in a polishing liquid composition, and a depth filter 3, a filter aid-including filter 4, and a pleats filter 5 are connected in series through pipes P1 to 4 in this order. A raw silica dispersion 2 poured into a tank 1 is subjected to one pass filtration in a filtration system including the depth filter 3, the filter aid-including filter 4, and the pleats filter 5 to become silica particles to be used in a polishing liquid composition.

Thus, as another embodiment of the production processes (2) and (3) of the present invention, it is preferred that the production processes (2) and (3) of the present invention include, as a step 3, the step of filtering the silica dispersion obtained in the step 2 of the production processes (2) and (3) of the present invention with a pleats filter.

When the embodiment shown in FIG. 1 of the production processes (2) and (3) of the present invention is compared with a conventional process for preparing silica particles shown in FIG. 2, it is understood that there is an advantage in that, even in one pass filtration with circulating filtration of the depth filter 3 omitted, silica particles and a polishing liquid composition of quality (less number of coarse particles, and/or less number of scratches and particles after polishing) equal to or higher than that of the conventional preparation process can be produced, and production time is shortened, resulting in enhancement of productivity. Further, even when a slurry of inexpensive general-purpose colloidal silica is used as the raw silica dispersion 2 without using a silica slurry subjected to an additional treatment such as a silica slurry 6 of FIG. 2, there is an advantage in that silica particles and a polishing liquid composition of quality equal to or higher than that of the conventional preparation process can be produced, and production time is shortened, resulting in enhancement of productivity.

The term “general-purpose colloidal silica” as used herein refers to colloidal silica that is generally being distributed on the market. Alternatively, the term “general-purpose colloidal silica” as used herein refers to colloidal silica in which an amount of coarse particles is, for example, 20.0×10⁴ pieces/mL or more, 30.0×10⁴ pieces/mL or more, or 34.0×10⁴ pieces/mL or more. Examples of an upper limit of the amount of coarse particles include 200.0×10⁴ pieces/mL or less, 100.0×10⁴ pieces/mL or less, and 70.0×10⁴ pieces/mL or less. Thus, the amount of coarse particles of general-purpose colloidal silica to be used in the present invention is preferably 20.0×10⁴ to 200.0×10⁴ pieces/mL, more preferably 20.0×10⁴ to 100.0×10⁴ pieces/mL, still more preferably 30.0×10⁴ to 100.0×10⁴ pieces/mL, 34.0×10⁴ to 100.0×10⁴ pieces/mL, still further preferably 34.0×10⁴ to 70.0×10⁴ pieces/mL.

Specific examples of the depth filter to be used in the production process of the present invention include not only bag type filters (Sumitomo 3M Ltd., etc.) but also cartridge type filters (Advantec Toyo Kaisha Ltd., Pall Corporation, 3M Purification Ltd., Daiwabo Co. Ltd., etc.).

The depth filter has a feature in that a porous structure of a filter material is coarse on an inlet side and fine on an outlet side, and becomes finer continuously or gradually from the inlet side to the outlet side. That is, the depth filter collects large particles of coarse particles in the vicinity of the inlet side and collect small particles in the vicinity of the outlet side, and hence, is capable of performing effective filtration. The shape of the depth filter may be a bag type in a bag shape or a cartridge type in a hollow cylindrical shape. Further, a filter material having the above-mentioned feature simply molded in a folded shape is classified into the depth filter, because such a filter material has a function of the depth filter.

The depth filter may have one stage or a combination of multiple stages (for example, in series arrangement). From the viewpoint of enhancing productivity, it is preferred that filters having different opening diameters be formed in multiple stages in decreasing order of diameter. A combination of a bag type and a cartridge type may be used. In multistage filtration, control of a particle diameter (filtering precision) of coarse particles to be removed and cost efficiency can be enhanced by appropriately selecting an opening diameter of a suitable filter and a structure of a filter material in accordance with the number of coarse particles in a raw silica dispersion, and further, appropriately selecting a treatment order of the filters. That is, when a filter having a large porous structure is used in a front stage (upstream side) from a fine filter, there is an effect that the life of the filters can be extended in the entire production steps.

As the pleats filter to be used in the production process of the present invention, a cartridge type in a hollow cylindrical shape obtained by molding a filter material in a folded shape (pleats shape) (Advantec Toyo Kaisha Ltd., Pall Corporation, 3M Purification Ltd., Daiwabo Co. Ltd., etc.) generally can be used. Unlike the depth filter that collects particles in each portion in a thickness direction, the pleats filter includes a filter material having a small thickness, and is considered to collect particles mainly on a surface of the filter. In general, the pleats filter has high filtering precision.

The pleats filter may have one stage or a combination of multiple stages (for example, in series arrangement). Further, the multifiltration can enhance productivity of the polishing liquid composition of the present invention by appropriately selecting an opening diameter of a suitable filter and a structure of a filter material in accordance with the number of coarse particles and appropriately selecting a treatment order of the filters. That is, when a filter having a large porous structure is used in a front stage (upstream side) from a fine filter, the life of the filters can be extended in an entire production process. Regarding filters used later, by designing filters having the same opening diameter in multiple stages, the quality of the polishing liquid composition can be stabilized further.

In an entire filtration step, it is preferred to perform filtration using a depth filter, filtration using a filter aid-including filter, and filtration using a pleats filter in this order, because the entire lives of the filters can be extended, and the polishing liquid composition of the present invention can be produced economically.

Opening diameters of the depth filter and the pleats filter are expressed generally as filtering precision at which particles can be removed by 99%. For example, an opening diameter of 1.0 μm refers to a filter capable of removing particles having a diameter of 1.0 μm by 99%. It is preferred that the opening diameter exceed 0.0 μm so that the function of a filter can be exhibited.

The opening diameter of the depth filter is preferably 5.0 μm or less, more preferably 3.0 μm or less, still more preferably 2.0 μm or less, still further preferably 1.0 μm or less, still further preferably 0.5 μm or less, from the viewpoint of reducing burden for removing coarse particles.

In the case where the depth filter is designed in multiple stages (for example, in series arrangement), when a final filter having an opening diameter of submicron or less is used, the burden for removing coarse particles in the filtration using a filter aid-including filter is further reduced, and productivity can be enhanced further.

The opening diameter of the pleats filter is preferably 1.0 μm or less, more preferably 0.8 μm or less, still more preferably 0.6 μm or less, still further preferably 0.5 μm or less, from the viewpoint of reducing coarse particles.

As a filtration method in the present invention, a circulating system in which filtration is performed repeatedly or a one pass system may be used. A batch system in which the one pass system is repeated may be used. As a liquid passing method, for applying pressure, a pump is preferably used in the circulating system, and in the one pass system, a pressure filtration method in which a variation width of a filter inlet pressure is reduced by introducing an air pressure of the like into a tank, as well as a pump, can be used.

In the production process of the present invention, in addition to the use of the depth filter and the pleats filter, a general dispersion step or particle removal step may be provided. For example, a dispersion step using a high-speed dispersion device or a high-pressure dispersion device such as a high-pressure homogenizer, and a precipitation step of coarse particles through use of a centrifugal device or the like also can be used. In the case of treating particles through use of these devices, each treatment may be performed alone or a combined treatment of at least two kinds may be performed. There is no particular limit to a combined treatment order. Further, a treatment condition and a treatment number also can be selected and used appropriately.

The term “raw silica dispersion” as used herein refers to a silica slurry (silica dispersion) before being subjected to filtration through use of a filter aid-including filter. Further, in the case of including filtration through use of a filtration system in which the filter aid-including filter, the depth filter, and/or the pleats filter are combined (for example, in the case of the production process (2) of the present invention and the production process (3) of the present invention), the “raw silica dispersion” can refer to a silica dispersion that is introduced into an initial filter (filter in the first stage) of the filtration system. In one embodiment, the raw silica dispersion is a dispersion containing colloidal silica and water, and examples thereof include a dispersion composed of colloidal silica and water, a dispersion further containing other components in addition to colloidal silica and water, and a slurry of general-purpose colloidal silica. In another embodiment, examples of the raw silica dispersion include those which are produced by mixing other components to be compounded in a polishing liquid composition described later. It is preferred that the raw silica dispersion have a state in which colloidal silica is dispersed.

In the present invention, a polishing liquid composition can be produced by subjecting a raw silica dispersion containing colloidal silica having an average primary-particle diameter of 1 to 100 nm to filtration through use of a filter aid-including filter. Specifically, a polishing liquid composition can be produced by subjecting a raw silica dispersion produced by mixing colloidal silica, water, and other components to the above-mentioned filtration or subjecting a raw silica dispersion containing colloidal silica and water to the above-mentioned filtration, and thereafter, mixing other components with the obtained filtrate (filtered silica slurry).

Colloidal silica to be used in the present invention can be obtained by, for example, a production process of generating colloidal silica from silicic acid aqueous solution. Further, these polishing particles whose surface is modified or reformed with a functional group, the polishing particles formed into composite particles with a surfactant or another polishing material, and the like can be used.

The average primary-particle diameter of colloidal silica is 1 to 100 nm, preferably 1 to 80 nm, from the viewpoint of reducing scratches and particles and from the viewpoint of reducing surface roughness (center line average roughness: Ra, peak to valley value: Rmax). Simultaneously, from the viewpoint of enhancing a polishing speed, the average primary-particle diameter of colloidal silica is more preferably 3 to 80 nm, still more preferably 4 to 50 nm, still further preferably 5 to 40 nm, still further preferably 5 to 30 nm. Herein, the average primary-particle diameter of colloidal silica is a value measured by the method described in the examples.

The content of colloidal silica in the raw silica dispersion is preferably 1 to 50% by weight, more preferably 10 to 45% by weight, still more preferably 20 to 40% by weight, still further preferably 30 to 40% by weight, from the viewpoint of reducing scratches and particles and from the viewpoint of enhancing productivity.

Further, the content of coarse particles in the raw silica dispersion is generally 1×10⁴ to 200×10⁴ pieces/mL, and preferably 100×10⁴ pieces/mL, more preferably 70×10⁴ pieces/mL or less, still more preferably 50×10⁴ pieces/mL or less, still further preferably 40×10⁴ pieces/mL or less, from the viewpoint of reducing scratches and particles. The content of coarse particles in the raw silica dispersion is preferably 1×10⁴ to 100×10⁴ pieces/mL, more preferably 1×10⁴ to 70×10⁴ pieces/mL, still more preferably 1×10⁴ to 50×10⁴ pieces/mL, still further preferably 1×10⁴ to 40×10⁴ pieces/mL, from the viewpoint of reducing scratches and particles and enhancing productivity.

On the other hand, in the production processes (2) and (3) of the present invention, from the viewpoint of enhancing productivity, the raw silica dispersion may be a slurry of general-purpose colloidal silica or a silica slurry having a coarse particle amount of 20.0×10⁴ pieces/mL or more, 30.0×10⁴ pieces/mL or more, or 34.0×10⁴ pieces/mL or more. Thus, from the viewpoint of reducing scratches and particles and from the viewpoint of enhancing productivity, the coarse particle amount is 20.0×10⁴ to 200×10⁴ pieces/mL, more preferably 30.0×10⁴ to 100×10⁴ pieces/mL, still more preferably 34.0×10⁴ to 70×10⁴ pieces/mL. Herein, the content of coarse particles in the raw silica dispersion is a value measured by the method described in the examples.

The 0.45 μm filter liquid passing quantity of the raw silica dispersion is generally 1 to 10 mL, and preferably 2 to 10 mL, more preferably 3 to 10 mL, still more preferably 4 to 10 mL, still further preferably 5 to 10 mL, from the viewpoint of reducing scratches and particles and from the viewpoint of enhancing productivity. Herein, the 0.45 μm filter liquid passing quantity of the raw silica dispersion is a value measured by the method described in the examples.

Further, the ΔCV value of the raw silica dispersion is generally 1 to 20%, and preferably 1 to 15%, more preferably 1 to 13%, still more preferably 1 to 12%, still further preferably 1 to 11%, from the viewpoint of reducing scratches and particles and from the viewpoint of enhancing productivity.

Herein, the ΔCV value of the raw silica dispersion is a difference (ΔCV=CV30−CV90) between a value (CV30) of a variable coefficient obtained by dividing a standard deviation by an average particle diameter and multiplying the result by 100, obtained by measurement based on a scattering intensity distribution at a detection angle of 30° (forward scattering) by dynamic light scattering method, and a value (CV90) of a variable coefficient obtained by dividing a standard deviation by an average particle diameter and multiplying the result by 100, obtained by measurement based on a scattering intensity distribution at a detection angle of 90° (lateral scattering). Specifically, the ΔCV value can be measured by the method described in the examples.

There is a correlation between the ΔCV value of a polishing liquid composition and the content of colloidal silica aggregate (non-spherical particles) considered to be derived from coarse particles and sediment. Therefore, it is considered that, by adjusting the ΔCV value of the polishing liquid composition in the above-mentioned predetermined range, scratches and particles after polishing can be reduced (see: JP 2011-13078 Å).

From the viewpoint of enhancing a polishing speed, the content of colloidal silica in a polishing liquid composition for polishing a substance to be polished is preferably 0.5% by weight or more, more preferably 1% by weight or more, still more preferably 2% by weight or more, still further preferably 3% by weight or more, still further preferably 5% by weight or more. Further, from the viewpoint of enhancing surface quality economically, the content of colloidal silica in a polishing liquid composition for polishing a substance to be polished is preferably 20% by weight or less, more preferably 15% by weight or less, still more preferably 13% by weight or less, still further preferably 10% by weight or less. Therefore, from the viewpoint of enhancing a polishing speed and enhancing surface quality economically, the content of colloidal silica in a polishing liquid composition for polishing a substance to be polished is preferably 0.5 to 20% by weight, more preferably 1 to 15% by weight, still more preferably 2 to 13% by weight, still further preferably 3 to 10% by weight, still further preferably 5 to 10% by weight. Herein, the content of colloidal silica may be any of a content during production of a polishing liquid composition or a content during use. Generally, colloidal silica is produced as a concentrate and diluted at a time of use in most cases.

Examples of water to be used in the polishing liquid composition include ion exchange water, distilled water, and ultrapure water. The content of water in the polishing liquid composition corresponds to a remaining portion obtained by removing a polishing material and other components from 100% by weight, and preferably 60 to 99% by weight, more preferably 80 to 97% by weight.

From the viewpoint of suppressing the formation of coarse particles and enhancing stability of colloidal silica, the pH of the raw silica dispersion is preferably 9 to 11, more preferably 9.2 to 10.8, still more preferably 9.4 to 10.6, still further preferably 9.5 to 10.5. Further, although there is no particular limit to the pH of the polishing liquid composition to be produced in the present invention, when the polishing liquid composition is used for polishing, the pH thereof is preferably 0.1 to 7. Scratches tend to occur in an alkaline state, compared with an acidic state. Although the occurrence mechanism thereof is not clear, it is presumed that, in an alkaline atmosphere in which polishing particles react strongly with each other due to surface charge, an aggregate of polishing primary particles or coarse polishing primary particles contained in the polishing liquid composition cannot perform dense filling in a polishing portion and are subject to a local load under a polishing pressure easily. The pH is preferably determined depending upon the kind of a substance to be polished and required characteristics. When the material for a substance to be polished is a metal material, from the viewpoint of enhancing a polishing speed, the pH of the polishing liquid composition is preferably 6 or less, more preferably 5 or less, still more preferably 4 or less, still further preferably 3 or less, still further preferably 2 or less. Further, from the viewpoint of influence on a human body and preventing corrosion of a polishing device, the pH is preferably 0.5 or more, more preferably 1.0 or more, still more preferably 1.4 or more. In a substrate for a precision component in which a material for a substance to be polished is a metal material, such as an aluminum alloy substrate plated with nickel-phosphorus (Ni—P), the pH is preferably 0.5 to 6, more preferably 1.0 to 5, still more preferably 1.4 to 4, still further preferably 1.4 to 3, still further preferably 1.4 to 2 considering the above-mentioned viewpoints.

The pH of the polishing liquid composition can be appropriately adjusted with, for example, the following acid, salt, or alkali. Specific examples thereof include inorganic acids such as nitric acid, sulfuric acid, nitrous acid, persulfuric acid, hydrochloric acid, perchloric acid, phosphoric acid, phosphonic acid, phosphinic acid, pyrophosphoric acid, tripolyphosphoric acid, and amidosulfonic acid, or salts thereof, organic phosphonic acids such as 2-aminoethylphosphonic acid, 1-hydroxyethylidene-1,1-diphosphonic acid, aminotri(methylenephosphonic acid), ethylenediaminetetra(methylenephosphonic acid), diethylenetriaminepenta(methylenephosphonic acid), ethane-1,1-diphosphonic acid, ethane-1,1,2-triphosphonic acid, ethane-1-hydroxy-1,1-diphosphonic acid, ethane-1-hydroxy-1,1,2-triphosphonic acid, ethane-1,2-dicarboxy-1,2-diphosphonic acid, methanehydroxyphosphonic acid, 2-phosphonobutane-1,2-dicarboxylic acid, 1-phosphonobutane-2,3,4-tricarboxylic acid, α-methylphosphonosuccinic acid, or salts thereof, amino carboxylic acids such as glutamic acid, picolinic acid, and aspartic acid, or salts thereof, and carboxylic acids such as oxalic acid, nitrosuccinic acid, maleic acid, and oxaloacetic acid, or salts thereof. Of those, inorganic acids or organic phosphonic acids and salts thereof are preferred, from the viewpoint of reducing scratches.

Of the above-mentioned inorganic acids or salts thereof, nitric acid, sulfuric acid, hydrochloric acid, perchloric acid, or salts thereof are more preferred. Of the above-mentioned organic phosphonic acids or salts thereof, 1-hydroxyethylidene-1,1-diphosphonic acid, aminotri(methylenephosphonic acid), ethylenediaminetetra(methylenephosphonic acid), diethylenetriaminepenta(methylenephosphonic acid), or salts thereof are more preferred. These acids or salts may be used alone or in combination of at least two kinds.

There is no particular limit to the salts of the above-mentioned acids, and specific examples thereof include salts of metal, ammonia, and alkylamine. Specific examples of the metal include those belonging to Groups 1A, 1B, 2A, 2B, 3A, 3B, 4A, 6A, 7A, or 8 in the periodic table (long form). From the viewpoint of reducing scratches, metals belonging to ammonia or Group 1A are preferred.

It is preferred that the polishing liquid composition for polishing a substance to be polished contain a heterocyclic aromatic compound, from the viewpoint of reducing scratches and particles on a polished substrate.

It is preferred that the heterocyclic aromatic compound be 1H-benzotriazaole, from the viewpoint of reducing scratches and particles on a polished substrate.

The content of the heterocyclic aromatic compound in the polishing liquid composition is preferably 0.01 to 10% by weight, more preferably 0.02 to 5% by weight, still more preferably 0.05 to 2% by weight, still further preferably 0.06 to 1% by weight, still further preferably 0.07 to 0.5% by weight, still further preferably 0.08 to 0.3% by weight with respect to the total weight of the polishing liquid composition, from the viewpoint of reducing scratches and particles on a polished substrate. One kind or at least two kinds of the heterocyclic aromatic compounds may be included in the polishing liquid composition.

It is preferred that the polishing liquid composition for polishing a substance to be polished contain a water-soluble polymer having an anionic group (hereinafter, sometimes referred to as “anionic water-soluble polymer”), from the viewpoint of reducing scratches and particles on a polished substrate and a maximum value of surface roughness (AFM-Rmax). It is presumed that the polymer decreases friction vibration during polishing to prevent a silica aggregate from coming off from an aperture of a polishing pad and reduces scratches on a polished substrate and a maximum value of surface roughness (AFM-Rmax).

Examples of the anionic group of the anionic water-soluble polymer include a carboxylic acid group, a sulfonic acid group, a sulfate group, a phosphate group, and a phosphonic acid group. From the viewpoint of reducing scratches and particles and a maximum value of surface roughness (AFM-Rmax), anionic water-soluble polymers having a carboxylic acid group and/or a sulfo group are preferred, and anionic water-soluble polymers having a sulfo group are more preferred. These anionic groups may take a form of neutralized salts.

An example of the water-soluble polymer having a carboxylic acid group and/or a sulfo group is a (meth)acrylic acid/sulfonic acid copolymer, and a (meth)acrylic acid/2-(meth)acrylamide-2-methylpropanesulphonic acid copolymer is preferred.

From the viewpoint of reducing scratches and particles and maintaining productivity, the weight average molecular weight of the anionic water-soluble polymer is preferably 500 to 100,000, more preferably 500 to 50,000, still more preferably 500 to 20,000, still further preferably 1,000 to 10,000, still further preferably 1,000 to 8,000, still further preferably 1,000 to 5,000, still further preferably 1,000 to 4,000, still further preferably 1,000 to 3,000. The weight average molecular weight is specifically measured by a measurement method described in the examples.

From the viewpoint of satisfying both the reduction of scratches and particles and the enhancement of productivity, the content of the anionic water-soluble polymer in the polishing liquid composition is preferably 0.001 to 1% by weight or more, more preferably 0.005 to 0.5% by weight, still more preferably 0.08 to 0.2% by weight, still more preferably 0.01 to 0.1% by weight, still more preferably 0.01 to 0.075% by weight.

It is preferred that the polishing liquid composition for polishing a substance to be polished contain an aliphatic amine compound or an alicylic amine compound, from the viewpoint of reducing scratches and particles on a surface of a polished substrate.

The aliphatic amine compound be N-aminoethylethanolamine, from the viewpoint of reducing scratches and particles on a surface of a polished substrate.

It is preferred that the alicyclic amine compound be N-(2-aminoethyl)piperazine and hydroxyethylpiperazine, from the viewpoint of reducing scratches and particles on a surface of a polished substrate.

The content of the aliphatic amine compound or the alicyclic amine compound in the polishing liquid composition is preferably 0.001 to 10% by weight, more preferably 0.005 to 5% by weight, still more preferably 0.008 to 2% by weight, still further preferably 0.01 to 1% by weight, still further preferably 0.01 to 0.5% by weight, still further preferably 0.01 to 0.1% by weight with respect to the total weight of the polishing liquid composition, from the viewpoint of reducing scratches and particles on a surface of a polished substrate. One kind or at least two kinds of the aliphatic amine compounds or the alicyclic amine compounds may be included in the polishing liquid composition.

It is preferred that the polishing liquid composition contain an oxidizing agent, from the viewpoint of enhancing a polishing speed. Examples of the oxidizing agent that can be used in the polishing liquid composition of the present invention include a peroxide, permanganic acid or a salt thereof, chromic acid or a salt thereof, peroxoacid or a salt thereof, oxygen acid or a salt thereof, metal salts, nitric acids, and sulfuric acids, from the viewpoint of enhancing a polishing speed.

Examples of the peroxide include a hydrogen peroxide, sodium peroxide, and barium peroxide. An example of permanganic acid or a salt thereof is potassium permanganate. Examples of chromic acid or a salt thereof include a chromic acid metal salt and a dichromic acid metal salt. Examples of peroxoacid or a salt thereof include peroxodisulfuric acid, ammonium peroxydisulfate, a peroxodisulfuric acid metal salt, peroxophosphoric acid, peroxosulfuric acid, sodium peroxoborate, performic acid, peracetic acid, perbenzoic acid, and perphthalic acid. Examples of oxygen acid or a salt thereof include hypochlorous acid, hypobromous acid, hypoiodous acid, chloric acid, bromic acid, iodic acid, sodium hypochlorite, and calcium hypochlorite. Examples of the metal salts include iron (III) chloride, iron (III) sulfate, iron (III) nitrate, iron (III) citrate, and ammonium iron (III) sulfate.

Examples of a preferred oxidizing agent include hydrogen peroxide, iron (III) nitrate, peracetic acid, ammonium peroxydisulfate, iron (III) sulfate, and ammonium iron (III) sulfate. A more preferred oxidizing agent is hydrogen peroxide, from the viewpoint of being used for general purposes without metal ions adhering to a surface and being inexpensive. These oxidizing agents may be used alone or in combination of at least two kinds.

The content of the oxidizing agent in the polishing liquid composition is preferably 0.01% by weight or more, more preferably 0.05% by weight or more, still more preferably 0.1% by weight or more, from the viewpoint of enhancing a polishing speed, and the content is preferably 4% by weight or less, more preferably 2% by weight or less, still more preferably 1% by weight or less, from the viewpoint of reducing surface roughness of a substrate. Therefore, in order to enhance a polishing speed while maintaining surface quality, the content is preferably 0.01 to 4% by weight, more preferably 0.05 to 2% by weight, still more preferably 0.1 to 1% by weight.

Further, other components may be compounded in the polishing liquid composition, if required. Examples of the other components include a thickener, a dispersing agent, a rust-preventive agent, a basic substance, and a surfactant.

The filter (opening diameter: 0.45 μm) liquid passing quantity of the polishing liquid composition obtained by the production process of the present invention is preferably 25 mL or more, more preferably 30 mL or more, still more preferably 50 mL or more, still further preferably 70 mL or more, still further preferably 100 mL or more, from the viewpoint of reducing scratches and particles. Herein, the filter liquid passing quantity of the polishing liquid composition is a value measured by the method described in the examples.

The content of coarse particles in the polishing liquid composition obtained by the production process of the present invention is preferably 0.5×10⁴ to 10×10⁴ pieces/mL, more preferably 0.5×10⁴ to 5×10⁴ pieces/mL, still more preferably 0.5×10⁴ to 4×10⁴ pieces/mL, still further preferably 0.5×10⁴ to 3×10⁴ pieces/mL, from the viewpoint of reducing scratches and particles and enhancing productivity. Herein, the content of the coarse particles in the polishing liquid composition is measured by the method described in the examples.

Further, the ΔCV value of the polishing liquid composition obtained by the production process of the present invention is preferably 0.1 to 10%, more preferably 0.1 to 5.0%, still more preferably 0.1 to 4.0%, still further preferably 0.1 to 3.0%, still further preferably 0.1 to 2.5%, from the viewpoint of reducing scratches and particles and enhancing productivity.

The polishing liquid composition obtained by the production process of the present invention is supplied, for example, between organic polymer based polishing cloth (polishing pad) of nonwoven fabric and a substrate to be polished, that is, the polishing liquid composition is supplied to a substrate surface to be polished sandwiched by polishing boards with polishing pads attached thereto, and the polishing boards and/or the substrate are moved under a predetermined pressure, whereby the polishing liquid composition is used in the polishing step while being in contact with the substrate. This polishing can remarkably suppress the occurrence of scratches and particles.

The polishing liquid composition is particularly preferred for production of a substrate for a precision component. The polishing liquid composition is suitable for polishing substrates of magnetic recording media such as a magnetic disk and a magnetooptical disk; and substrates for a precision component such as an optical disk, a photomask substrate, an optical lens, an optical mirror, an optical prism, and a semiconductor substrate. For producing a semiconductor substrate, the polishing liquid composition obtained by the production process of the present invention can be used in the step of polishing a silicon wafer (bare wafer), the step of forming a buried element separation film, the step of flattening an interlayer insulating film, the step of forming buried metal wiring, and the step of forming a buried capacitor.

Although the polishing liquid composition obtained by the production process of the present invention is particularly effective in the polishing step, the polishing liquid composition also can be applied similarly to, for example, other polishing steps such as a wrapping step.

Examples of a preferred material for a substance to be polished, using the polishing liquid composition obtained by the production process of the present invention, include metals or semi-metals such as silicon, aluminum, nickel, tungsten, copper, tantalum, and titanium, or alloys thereof, glass materials such as glass, glass carbon, and amorphous carbon; ceramic materials such as alumina, silicon dioxide, silicon nitride, tantalum nitride, and titanium carbide; and resins such as a polyimide resin. Of those, substances to be polished containing metals such as aluminum, nickel, tungsten, and copper, and substances to be polished containing alloys that contain these metals as main components are preferred. For example, an aluminum alloy substrate plated with Ni—P, and glass substrates such as crystallized glass and reinforced glass are more preferred, and an aluminum alloy substrate plated with Ni—P is further preferred.

There is no particular limit to the shape of the substance to be polished, and the polishing liquid composition of the present invention is used in, for example, those which have a flat portion such as a disk shape, a plate shape, a slab shape, and a prism shape; and those which have a curved portion such as a lens. Of those, the polishing liquid composition of the present invention is excellent in polishing a disk-shaped object to be polished.

Although the method for evaluating surface roughness, which indicates surface smoothness, is not limited, for example, the surface roughness is evaluated as roughness capable of being measured with a short wavelength of 10 μm or less in the atomic force microscope (AFM), and can be expressed as center line average roughness Ra (AFM-Ra). The polishing liquid composition of the present invention is suitable for the step of polishing a magnetic disk substrate, and further, the polishing step involving setting surface roughness (AFM-Ra) of a polished substrate to 2.0 Å.

In the case where the step of producing a substrate includes a plurality of polishing steps, it is preferred to use the polishing liquid composition obtained by the production process of the present invention in the second and subsequent steps, and from the viewpoint of obtaining excellent surface smoothness with scratches and particles remarkably reduced, it is more preferred to use the polishing liquid composition in a finish-polishing step. The finish-polishing step refers to at least one last polishing step in the case where there is a plurality of polishing steps.

In this case, in order to prevent contamination of a polishing material in the previous step and the polishing liquid composition, separate polishing machines may be used respectively. Further, in the case where separate polishing machines are used respectively, it is preferred that a substrate be cleaned in each step. There is no particular limit to the polishing machine. A substrate thus produced has excellent surface smoothness, in which scratches and particles are remarkably reduced. That is, the surface roughness (AFM-Ra) after polishing is, for example, 1 Å or less, preferably 0.9 Å or less, more preferably 0.8 Å or less.

Although there is no particular limit to surface properties of a substrate before being subjected to the polishing step using the polishing liquid composition after filtration using the filter aid-including filter in the present invention, a substrate having surface properties of AFM-Ra of 10 Å or less is suitable.

A polishing material to be used in production of such a substrate only needs to be the same as that used for the polishing liquid composition of the present invention. The polishing step is performed preferably in the second step or subsequent steps of a plurality of polishing steps, more preferably in the finish-polishing step.

The substrate thus produced is excellent in surface smoothness, in which surface roughness (AFM-Ra) is, for example, 1.0 Å or less, preferably 0.9 Å or less, more preferably 0.8 Å or less.

Further, the produced substrate has a very few scratches. Thus, in the case where the substrate is, for example, a memory hard disk substrate, the substrate also can handle a recording density of 750 GB/Disk (3.5 inch), further 1 TB/Disk (3.5 inch).

### EXAMPLES

### 1. Examples 1-9, Comparative Examples 1-8

A raw silica dispersion was filtered through use of a diatomaceous earth filter to produce each polishing liquid composition by production processes of Examples 1-9 and Comparative Examples 1-8. A substrate was polished with the polishing liquid composition, and a polished substrate surface was evaluated. The raw silica dispersion, the diatomaceous earth filter, a filtration method, and methods for measuring various parameters are as follows.

<Raw Silica Dispersion>

As the raw silica dispersion, a colloidal silica slurry A (average primary-particle diameter: 24 nm, silica particle concentration: 40% by weight, pH: 10.0, produced by JGC Catalysts & Chemicals Co., Ltd.), a colloidal silica slurry B (average primary-particle diameter: 50 nm, silica particle concentration: 40% by weight, pH: 9.7, produced by JGC Catalysts & Chemicals Co., Ltd.), and a colloidal silica slurry C (average primary-particle diameter: 24 nm, silica particle concentration: 40% by weight, pH: 10.0, produced by JGC Catalysts & Chemicals Co., Ltd. were used.

<Method for Measuring an Average Primary-Particle Diameter of Colloidal Silica>

First, 1.5 g (solid content) each of the colloidal silica slurries A to C were collected in a 20 mL beaker, and 100 mL of ion exchange water was added thereto, followed by mixing with a stirrer. Next, the pH of the sample solution was adjusted to 3.0 with a 0.1 mol/L of hydrochloric acid standard solution through use of a potentiometric titrator. Thirty grams of sodium chloride was added to the resultant sample solution and dissolved therein with a stirrer. Ion exchange water was added to the sample solution up to a 150 mL reference line of the beaker, followed by mixing with a stirrer. The beaker was soaked in a constant temperature water tank (20±2° C.) for about 30 minutes. The sample solution was titrated with a 0.1 mol/L sodium hydroxide standard solution through use of the potentiometric titrator, and a consumption amount (A) of the sodium hydroxide standard solution when the pH changed from 4.0 to 9.0 was read. Simultaneously, a blank test was performed, and a consumption amount (B) of the sodium hydroxide standard solution required for titration in the blank test is read. Then, an average particle diameter (nm) is calculated by the following calculation expression.

Average particle diameter (nm)=3100÷26.5×(A−B)÷collected amount of sample (g)

<Method for Measuring a ΔCV Value>

A measurement sample was prepared by adding a colloidal silica slurry before (or after) being filtered with a filter aid-including filter to an aqueous solution in which sulfuric acid (super-high grade produced by Wako Pure Chemical Industries, Ltd.), HEDP (1-hydroxyethylidene-1,1-diphosphonic acid, produced by Thermos (Japan)), and a hydrogen peroxide solution (concentration: 35% by weight, produced by Asahi Denka Kogyo Co. Ltd.) were diluted with ion exchange water, and mixing the resultant solution, followed by filtering the solution with a 1.20 μm filter (Minisart 17593, produced by Sartorius Stedim Japan K.K.). The contents of the colloidal silica, sulfuric acid, HEDP, and hydrogen peroxide solution were respectively 5% by weight, 0.4% by weight, 0.1% by weight, and 0.4% by weight. Then, 20 mL of the obtained measurement sample was placed in a dedicated 21φ cylindrical cell, and set in a dynamic light scattering device (DLS-6500) produced by Otsuka Electronics Co., Ltd. A particle diameter at which an area of a scattering intensity distribution obtained by a Cumulant method at a detection angle of 90° when integrated 200 times became 50% of the entire area was obtained in accordance with an instruction manual attached to the device. Further, a CV value (CV90) of colloidal silica at a detection angle of 90° was calculated as a value obtained by dividing a standard deviation in the scattering intensity distribution measured in accordance with the above-mentioned measurement method by the particle diameter and multiplying the obtained value by 100. In the same way as in the measurement method of the CV90, a CV value (CV30) of colloidal silica at a detection angle of 30° was measured, and the CV90 was subtracted from the CV30 to obtain a ΔCV value of a silica particle.

(Measurement condition of DLS-6500)
Detection angle: 90°
Sampling time: 4 (μm)

### Correlation Channel: 256 (ch)

### Correlation Method: TI

Sampling temperature: 26.0 (° C.)
Detection angle: 30°
Sampling time: 10 (μm)

### Correlation Channel: 1024 (ch)

### Correlation Method: TI

Sampling temperature: 26.0 (° C.)

<Method for Measuring an Amount of Coarse Particles>

A colloidal silica slurry before (or after) being filtered with a filter aid-including filter was injected into the following measurement unit with a 6 mL syringe, whereby a measurement sample was measured for the amount of coarse particles.

Measurement unit: “AccuSizer 780APS” produced by Particle Sizing Systems Inc.

### Injection Loop Volume: 1 mL

Flow Rate: 60 mL/min.

### Data Collection Time 60 sec.

### Number of Channels: 128

### <Method for Measuring a Filter Liquid Passing Quantity>

A colloidal silica slurry before (or after) being filtered with a filter aid-including filter was passed through a predetermined filter (hydrophilic PTFE 0.45 μm filter, type: 25HP045AN, produced by Advantec Toyo Kaisha Ltd.) under a predetermined pressure (air pressure: 0.25 MPa), whereby a measurement sample was measured for a liquid passing quantity until the filter was closed.

<Average Pore Diameter of a Filter Aid and Method for Measuring an Integrated Pore Volume of 0.5 μm or Less>

About 0.1 to 0.3 g of each filter aid was precisely weighed with a four-digit balance, and a sample was placed in a 5 cc measurement cell for powder in which mercury was well washed with hexane so that the sample did not adhere to the inside of a stem or a frosted part, and the cell was set in AutoPore IV-9500 (mercury intrusion method, pore distribution measurement device, produced by Shimazu Corporation). Next, an application (AutoPore IV-9500 ver1.07) was started up with a personal computer, and requirements were input to Sample Information (weight of a filter aid measured in advance), Analysis Condition (select Standard), Penetrometer Property (cell weight), and Report condition (select Standard), whereby measurement was performed. Measurement was performed in the order of a low-pressure portion and a high-pressure portion, and automatically, results of a Log Differential Pore Volume (mL/g) with respect to Median pore diameter (Volume) (μm) and each Pore Size Diameter (μm) were obtained.

(Measurement Condition)

Measurement cell: 5 cc-Powder (08-0444), produced by Micromeritics Instrument Corporation
Measurement system: Pressure control system (pressure table mode)
Low pressure equilibrium time: 5 secs
High pressure equilibrium time: 5 secs
Parameters regarding Hg: contact angle: 130°, surface tension: 485 dynes/cm
Stem Volume Used: sample amount is adjusted to be equal to or less than 100% (about 50%)

(Method for Calculating an Average Pore Diameter)

A median pore diameter (volume) was defined as an average pore diameter (μm) of a filter aid.

(Method for Calculating an Integrated Pore Volume of 0.5 μm or Less)

A value of a log differential pore volume (mL/g) of 0.55 μm or less was integrated to obtain an integrated pore volume of 0.5 μm or less.

<Method for Measuring a BET Specific Surface Area of a Filter Aid)

About 1 g of each precisely weighed filter aid was set in ASAP2020 (Specific surface area•Pore distribution measurement device, produced by Shimazu Corporation), and a BET specific surface area was measured by a multi-point method to derive a value in a range in which a BET constant C became positive. The pretreatment of a sample was performed by raising the temperature of the sample by 10° C./min. and holding the sample at 100° C. for 2 hours. Further, the sample was degassed up to 500 μmHg at 60° C.

<Method for Measuring a Laser Average Particle Diameter of a Filter Aid>

A value obtained as a volume-based median diameter obtained by measuring each filter aid with a laser scattering particle size distribution analyzer (trade name: LA-920, produced by Horiba Ltd.) was defined as a laser average particle diameter.

<Method for Measuring an Integrated Pore Volume of 0.15 μm or Less>

An integrated pore volume of 0.15 μm or less of a filter aid was measured by a nitrogen adsorption method. Specifically, about 1 g of each precisely weighed filter aid was set in ASAP2020 (Specific surface area•Pore distribution measurement device, produced by Shimazu Corporation), and a total pore volume of 0.15 μm or less obtained by a Halsey system of a BJH method from a nitrogen adsorption isotherm was defined as an integrated power volume of 0.15 μm or less. The pretreatment of a sample was performed by raising the temperature of the sample by 10° C./min. and holding the sample at 100° C. for 2 hours. Further, the sample was degassed up to 500 μmHg at 60° C.

<Method for Measuring a Permeability of a Filter Aid>

Ultrapure water filtered with a hydrophilic PTFE 0.20 μm filter (25HP020AN) produced by Advantec Toyo Kaisha Ltd. was subjected to filtration measurement through use of a filter aid under a condition of 0.015 MPa. From the filtration time of the ultrapure water at this time, a permeability of the filter aid was calculated by the following mathematical expression (1).

k=1/A*dV/dθ*uL/P (1)

A: Permeation layer cross-sectional area [m²]
V: Permeation amount [m²]
θ: Permeation time [s]
k: Permeability [m²]
P: Pressure loss of a permeation layer [Pa]
u: Viscosity of a permeation fluid [Pa·s]
L: Thickness of a permeation layer [m]

When filtration was performed, a filter aid was sandwiched between No. 5A filter papers produced by Advantec Toyo Kaisha Ltd. and set in a 90 mmφ plate-type SUS housing (INLET 90-TL, effective filtration area: 55.4 cm², produced by Sumitomo 3M Ltd.), whereby filtration was performed.

In the current experiment system, a permeability k was calculated by substituting the following values into the mathematical expression (0 and L represent values varying for each sample).

A: 0.0055 [m²]
V: 0.0005 [m²]

### θ: Variable

### P: 15000 [Pa]

### u: 0.001 [Pa·s]

### L: Variable

<Production of a Filter Aid-Including Filter>

### (Filter Aid)

As a filter aid, the following a to k were used.

a: CelpureP65 (laser average particle diameter: 12.7 μm, diatomaceous earth, produced by SIGMAALDRICH Corp.)
b: Radiolight No. 100 (laser average particle diameter: 15.7 μm, diatomaceous earth, Showa Chemical Industry Co., Ltd.)
c: Radiolight DX-P5 (laser average particle diameter: 14.5 μm, diatomaceous earth, Showa Chemical Industry Co., Ltd.)
d: Radiolight No. 200 (laser average particle diameter: 13.9 μm, diatomaceous earth, Showa Chemical Industry Co., Ltd.)
e: Radiolight No. 500 (laser average particle diameter: 28.4 μm, diatomaceous earth, Showa Chemical Industry Co., Ltd.)
f: Radiolight No. 600 (laser average particle diameter: 21.9 μm, diatomaceous earth, Showa Chemical Industry Co., Ltd.)
g: Radiolight New Ace (laser average particle diameter: 31.6 μm, diatomaceous earth, Showa Chemical Industry Co., Ltd.)
h: Celite 500 fine (laser average particle diameter: 15.0 μm, diatomaceous earth, SIGMA ALDRICH Corp.)
i: Celpure 300 (laser average particle diameter: 12.6 μm, diatomaceous earth, SIGMA ALDRICH Corp.)
j: NA-500 (laser average particle diameter: 13.5 μm, diatomaceous earth, Advantec Toyo Kaisha Ltd.)
k: Radiolight Dx-W50 (laser average particle diameter: 25.2 μm, diatomaceous earth, Showa Chemical Industry Co., Ltd.)

(Acid Treatment)

200 mL of a 17.5% hydrochloric acid aqueous solution was added to 50 g of each of filter aids “a” to “k”, followed by stirring and mixing. Stirring was stopped and the aqueous solution was allowed to stand for about 48 hours. After that, supernatant was removed. Ion exchange water was added to the resultant solution and stirred with a stirrer for 5 minutes. The solution was allowed to stand until supernatant became transparent. Then, the supernatant was removed, and the filter aid was washed. This operation was repeated until the supernatant became neutral (pH=5 to 8). Finally, the solution thus obtained was filtered onto filter paper and dried naturally to obtain a filter aid treated with acid.

(Production of a Filter Aid-Including Filter)

To 10 g of the filter aid subjected to an acid treatment, 100 mL of ion exchange water was added, followed by stirring and mixing, to obtain a filter aid dispersion aqueous solution. Next, filter paper (No. 5A made of cellulose and having a holding particle diameter correlated to an opening of 7 μm, produced by Advantec Toyo Kaisha Ltd.) was set in a 90 mmφ plate-type SUS housing (INLET 90-TL, effective filtration area: 55.4 cm², produced by Sumitomo 3M Ltd.), and a filter aid dispersion aqueous solution was filtered under a pressure of 0.1 MPa or less to form a uniform cake layer of a filter aid on the filter paper. After that, the cake layer was washed with 1 to 2 L of ion exchange water to obtain a diatomaceous earth-including filter.

<Filtration of Colloidal Silicas a to C>

One liter each of the colloidal silica slurries A to C was filtered with the above-mentioned diatomaceous earth-including filter which remained wet with washing water without being dried under a pressure of 0.1 MPa to obtain each filtered colloidal silica to be used in a polishing liquid composition.

<Method for Measuring a Filter Liquid Passing Quantity>

The filtered colloidal silica obtained by filtration as described above was caused to pass through a predetermined filter (hydrophilic PTFE 0.45 μm filter, Type: 25HPO₄₅AN, produced by Advantec Toyo Kaisha Ltd.) under a predetermined air pressure of 0.25 MPa to obtain a liquid passing quantity by the time when the filter was closed.

### Preparation of a Polishing Liquid Composition

### Examples 1-4 and Comparative Examples 1-4

0.1% by weight of a benzotriazole sodium salt, 0.03% by weight of N-aminoethylethanolamine, 0.02% by weight of a sodium salt of an acrylic acid/acrylamide-2-methylpropane sulfonic acid copolymer (molar ratio: 90/10, weight average molecular weight: 2000, produced by Toagosei Co., Ltd.), 0.4% by weight of sulfuric acid, 0.05% by weight of 1-hydroxyethylidene-1,1-diphosphonic acid, and 0.4% by weight of hydrogen peroxide were added to and mixed with ion exchange water to obtain an aqueous solution. Each filtered colloidal silica having been filtered with the diatomaceous earth-including filter was added to the aqueous solution with stirring so as to be 5% by weight, thereby preparing a polishing liquid composition (Examples 1-4 and Comparative Examples 1-4). The pH of any of the polishing liquid compositions was 1.4 to 1.5.

### Preparation of a Polishing Liquid Composition

### Examples 5-9 and Comparative Examples 5-8

0.02% by weight of a sodium salt of an acrylic acid/acrylamide-2-methylpropane sulfonic acid copolymer (molar ratio: 90/10, weight average molecular weight: 2000, produced by Toagosei Co., Ltd.), 0.4% by weight of sulfuric acid, 0.05% by weight of 1-hydroxyethylidene-1,1-diphosphonic acid, and 0.4% by weight of hydrogen peroxide were added to and mixed with ion exchange water to obtain an aqueous solution. Each filtered colloidal silica having been filtered with the diatomaceous earth-including filter was added to the aqueous solution with stirring so as to be 5% by weight, thereby preparing a polishing liquid composition (Examples 5-9 and Comparative Examples 5-8). The pH of any of the polishing liquid compositions was 1.3 to 1.5.

<Method for Measuring a Weight Average Molecular Weight of an Anionic Water-Soluble Polymer>

The weight average molecular weight of an anionic water-soluble polymer (a sodium salt of an acrylic acid/acrylamide-2-methylpropane sulfonic acid copolymer) was measured by a gel permeation chromatography (GPC) method under the following measurement condition.

### (GPC Condition)

Column: TSKgel G4000PWXL+TSKgel G2500PWXL (produced by Tosoh Corporation)
Guard column: TSKguardcolumn PWXL (produced by Tosoh Corporation)
Eluant 0.2 M phosphate buffer/CH₃CN=9/1 (volume ratio)

### Temperature: 40° C.

Flow velocity: 1.0 mL/min.
Sample size: 5 mg/mL

### Detector: RI

Conversion standard: sodium polyacrylate (molecular weight (Mp):115,000; 28,000; 4,100; 1,250 (produced by Sowa Science Corporation and American Polymer Standards Corp.)

Substrates to be polished were polished with the polishing liquid compositions prepared by the production processes of Examples 1-9 and Comparative Examples 1-8 as described above and cleaned with pure water to obtain substrates for evaluation. The number of scratches and particles of the substrates for evaluation were evaluated. Table 1 shows the evaluation results. A method for preparing a polishing liquid composition, a method for measuring each parameter, a polishing condition (polishing method), a cleaning condition, and an evaluation method are as follows. As the substrate to be polished, an aluminum alloy substrate plated with Ni—P having an AFM-Ra of 5 to 15 Å, a thickness of 1.27 mm, an outer diameter of 95 mmφ, and an inner diameter of 25 mmφ, roughly polished with polishing liquid containing an alumina polishing material in advance, was used.

<Polishing Condition>

Polishing test machine: double-sided 9B polisher, produced by SpeedFam Co., Ltd.
Polishing pad: urethane-finished polishing pad, produced by Fujibo Holdings, Inc.
Number of revolutions of an upper surface plate: 32.5 r/min.
Polishing liquid composition supply amount: 100 mL/min.
Main polishing time: 4 minutes
Main polishing load: 7.8 kPa
Number of placed substrates: 10

<Cleaning Condition>

The polished substrate was cleaned with a Sub substrate cleaning machine produced by Hikari Co., Ltd. in the following steps.

(1) US (ultraviolet wave) soak cleaning (950 kHz)
(2) Scrub cleaning: three-tier sponge brush
(3) US shower cleaning (950 kHz)
(4) Spin rinse

### (5) Spin dry

<Condition for Measuring Scratches>

Measurement equipment: Candela OSA6100, produced by KLA-Tencor Corporation
Evaluation: Of the substrates placed in a polishing test machine, four substrates were selected at random, and each substrate was irradiated with a laser at 10,000 rpm and measured for scratches. The total number of scratches (lines) on both surfaces of the respective four substrates was divided by 8 to calculate the number of scratches per substrate surface.

<Condition for Measuring Particles>

Measurement equipment: Candela OSA6100, produced by KLA-Tencor Corporation
Evaluation: Of the substrates placed in a polishing test machine, four substrates were selected at random. The total number of particles (pieces) on both surfaces of the respective four substrates was divided by 8 to calculate the number of particles per substrate surface.

TABLE 1

| | | | Example | | | | | | | | |
|---|---|---|---|---|---|---|---|---|---|---|---|
| | | | 1 | 2 | 3 | 4 | 5 | 6 | 7 | 8 | 9 |
| Raw silica | Kind | | A | B | A | A | C | B | C | C | C |
| dispersion | Amount of coarse particles | 10⁴ pieces/mL | 34.9 | 44.9 | 34.9 | 34.9 | 34.6 | 44.9 | 34.6 | 34.6 | 34.6 |
| | 0.45 μm filter liquid | mL | 5 | 3 | 5 | 5 | 6 | 3 | 6 | 6 | 6 |
| | passing quantity | | | | | | | | | | |
| | ΔCV value | % | 10.8 | 14.3 | 10.8 | 10.8 | 11.2 | 14.3 | 11.2 | 11.2 | 11.2 |
| Physical | Diatomaceous earth filter acid | | a | a | b | c | h | h | c | i | j |
| properties of | Average pore diameter | μm | 2.3 | 2.3 | 2.7 | 2.1 | 2.4 | 2.4 | 2.1 | 2.6 | 3.1 |
| filter acid | Integrated pore volume of | mL/g | 5.1 | 5.1 | 5.2 | 3.3 | 5.4 | 5.4 | 3.3 | 4.6 | 2.8 |
| | 0.5 μm or less | | | | | | | | | | |
| | BET specific surface area | cm²/g | 19.7 | 19.7 | 5.1 | 4.7 | 20.3 | 20.3 | 4.7 | 4.3 | 7.2 |
| | Pore volume of 0.15 μm or less | mL/g | 0.6 | 0.6 | 0.5 | 0.7 | 0.6 | 0.6 | 0.7 | 0.6 | 0.4 |
| | Permeation time | s | 323 | 323 | 724 | 795 | 299 | 299 | 795 | 236 | 189 |
| | Thickness of permeation | m | 6.30 | 6.30 | 3.50 | 2.72 | 5.24 | 5.24 | 2.72 | 3.73 | 3.77 |
| | layer (×10⁻³) | | | | | | | | | | |
| | Permeability (×10⁻¹⁴) | m² | 1.3 | 1.3 | 2.5 | 2.1 | 1.6 | 1.6 | 2.1 | 4.8 | 12.0 |
| | Content of filter acid | g/cm² | 0.18 | 0.18 | 0.18 | 0.18 | 0.18 | 0.18 | 0.18 | 0.18 | 0.19 |
| Dispersion | Amount of coarse particles | 10⁴ pieces/mL | 2.2 | 3.9 | 2.7 | 2.9 | 2.9 | 3.8 | 2.9 | 3.4 | 4.9 |
| after | 0.45 μm filter liquid | mL | 370 | 64 | 74 | 87 | 214 | 114 | 94 | 80 | 46 |
| filtration | passing quantity | | | | | | | | | | |
| | ΔCV value | % | 1.8 | 2.1 | 2.2 | 2.1 | 1.5 | 2.2 | 2.3 | 2.5 | 3.1 |
| Polishing | Scratch | Lines/surface | 25 | 48 | 35 | 39 | 20 | 36 | 49 | 50 | 64 |
| evaluation | Particle | Pieces/surface | 250 | 388 | 301 | 296 | 215 | 344 | 343 | 384 | 438 |

| | | | Comparative Example | | | | | | | |
|---|---|---|---|---|---|---|---|---|---|---|
| | | | 1 | 2 | 3 | 4 | 5 | 6 | 7 | 8 |
| Raw silica | Kind | | A | A | A | A | C | C | C | C |
| dispersion | Amount of coarse particles | 10⁴ pieces/mL | 34.9 | 34.9 | 34.9 | 34.9 | 34.6 | 34.6 | 34.6 | 34.6 |
| | 0.45 μm filter liquid | mL | 5 | 5 | 5 | 5 | 6 | 6 | 6 | 6 |
| | passing quantity | | | | | | | | | |
| | ΔCV value | % | 10.8 | 10.8 | 10.8 | 10.8 | 11.2 | 11.2 | 11.2 | 11.2 |
| Physical | Diatomaceous earth filter acid | | d | e | f | g | d | e | k | g |
| properties of | Average pore diameter | μm | 4.2 | 6.8 | 9.1 | 14.7 | 4.2 | 6.8 | 7.2 | 14.7 |
| filter acid | Integrated pore volume of | mL/g | 1.9 | 1.7 | 2.1 | 0.0 | 1.9 | 1.7 | 0.7 | 0 |
| | 0.5 μm or less | | | | | | | | | |
| | BET specific surface area | cm²/g | 3.5 | 4.1 | 1.4 | 3.4 | 3.5 | 4.1 | 1.1 | 3.4 |
| | Pore volume of 0.15 μm or less | mL/g | 0.3 | 0.2 | 0.2 | 0.1 | 0.3 | 0.2 | 0.1 | 0.1 |
| | Permeation time | s | 460 | 152 | 136 | 97 | 460 | 152 | 95 | 97 |
| | Thickness of permeation | m | 3.56 | 4.61 | 3.90 | 5.09 | 3.56 | 4.61 | 4.93 | 5.09 |
| | layer (×10⁻³) | | | | | | | | | |
| | Permeability (×10⁻¹⁴) | m² | 4.7 | 18.2 | 17.7 | 31.6 | 4.7 | 18.2 | 31.1 | 31.6 |
| | Content of filter acid | g/cm² | 0.18 | 0.18 | 0.18 | 0.18 | 0.18 | 0.18 | 0.18 | 0.18 |
| Dispersion | Amount of coarse particles | 10⁴ pieces/mL | 3.7 | 2.2 | 2.6 | 3.4 | 2.5 | 3.9 | 4.1 | 3.8 |
| after | 0.45 μm filter liquid | mL | 21 | 8 | 7 | 6 | 24 | 8 | 9 | 8 |
| filtration | passing quantity | | | | | | | | | |
| | ΔCV value | % | 5.4 | 7.5 | 6.8 | 6.7 | 5.8 | 6.7 | 7.5 | 6.8 |
| Polishing | Scratch | Lines/surface | 85 | 95 | 100 | 118 | 97 | 103 | 120 | 114 |
| evaluation | Particle | Pieces/surface | 510 | 620 | 680 | 761 | 686 | 884 | 891 | 952 |

As is apparent from the results of Table 1, compared with the polishing liquid compositions obtained in Comparative Examples 1-8, the 0.45 μm filter liquid passing quantity of the polishing liquid compositions obtained in Examples 1-9 increases remarkably to exceed 10 times that before a treatment and can reduce scratches and particles effectively.

### 2. Example 10 and Comparative Examples 9-10

A raw silica dispersion was filtered with a filtration system including a combination of a depth filter, a diatomaceous earth-including filter, and a pleats filter to produce a polishing liquid composition (Example 10). Further, two kinds of raw silica dispersions were filtered with a filtration system including a combination of circulating filtration of a depth filter and a pleats filter to produce polishing liquid compositions (Comparative Examples 9-10). Substrates were polished through use of the respective polishing liquid compositions, and the surfaces of the substrates after polishing were evaluated. Unless otherwise described particularly, the methods for measuring various parameters shown in the following Table 2 were the same as those of Example 1.

<Raw Silica Dispersion>

As raw silica dispersions, a general-purpose colloidal silica slurry D (average primary-particle diameter: 24 nm, amount of coarse particles: 47.9×10⁴ pieces/mL, silica particle concentration: 40% by weight, pH=9.9, produced by JGC Catalysts & Chemicals Co., Ltd.) and a colloidal silica slurry E (average primary-particle diameter: 24 nm, amount of coarse particles: 6.9×10⁴ pieces/mL, silica particle concentration: 40% by weight, pH=9.9) obtained by subjecting the colloidal silica slurry D to centrifugation to reduce the amount of coarse particles were used.

### Process for Producing a Polishing Liquid Composition of Example 10

As a filtration system for obtaining filtered colloidal silica to be used in the polishing liquid composition of Example 10, a filtration system in which one depth filter in a first stage, one diatomaceous earth-including filter (cake filter) in a second stage, and one pleats filter in a third stage were arranged in series of three stages in this order was used. FIG. 1 shows a schematic view of the filtration system. The colloidal silica slurry D that was a raw silica dispersion was subjected to one pass filtration with the filtration system to obtain filtered colloidal silica. A polishing liquid composition was produced in the same way as in Example 1, using the obtained filtered colloidal silica. Time required for causing 50 L of the colloidal silica slurry D to pass through the filtration system with a small diaphragm pump was 0.9 hours (average liquid passing quantity: 0.95 L/min., average filtration speed: 17.9 L/(min·m²) (Table 2 shown below). The filters used herein are as follows.

Depth filter: “Profile II-003” (opening diameter: 0.3 μm) having a length of 250 mm, made of polypropylene, produced by Pall Corporation

Cake filter: Filter produced by setting filter paper (No. 5A made of cellulose, produced by Advantec Toyo Kaisha Ltd.) on Disk Holder KS-293-UH for multiple applications (effective filtering area: 530 cm²) produced by Advantec Toyo Kaisha Ltd., pre-coating the filter paper with a water dispersion of the diatomaceous earth filter aid “a” (no acid treatment) (100 g) to form a uniform cake layer, and thereafter, washing the filter aid with 10 L of ion exchange water

Please filter: “TCS-045” (opening diameter: 0.45 μm) made of polyether sulphone having a length of 250 mm, produced by Advantec Toyo Kaisha Ltd.

### Process for Producing a Polishing Liquid Composition of Comparative Example 9

As a first-stage filtration system for obtaining filtered colloidal silica to be used in the polishing liquid composition of Comparative Example 9, a filtration system in which two depth filters were arranged was used. Then, as a second-stage filtration system, a filtration system in which one pleats filter was arranged was used. FIG. 2 shows a schematic view of the filtration system. The colloidal silica slurry D that was a raw silica dispersion was subjected to circulating liquid passing filtration with the first-stage filtration system, whereby filtration apparently corresponding to 8 passes was performed. After that, the resultant colloidal silica slurry D was subjected to one pass filtration with the second-stage filtration system to obtain filtered colloidal silica. A polishing liquid composition was produced in the same way as in Example 1, using the obtained filtered colloidal silica. Time required for subjecting 50 L of the colloidal silica slurry D to circulating liquid passing through the first-stage filtration system, using a small diaphragm pump, to perform filtration apparently corresponding to 8 passes was 3.3 hours (average liquid passing quantity: 2.0 L/min). Further, time required for subjecting the colloidal silica slurry D to one pass filtration through the second-stage filtration system was 0.4 hours. Thus, total time required for the first-stage and second-stage filtrations was 3.7 hours (Table 2 shown below). The depth filter and the pleats filter used herein are the same as those of Example 10.

### Process for Producing a Polishing Liquid Composition of Comparative Example 10

A polishing liquid composition was produced in the same way as in Comparative Example 9, except for using the colloidal silica slurry E in place of the colloidal silica slurry D that was a raw silica dispersion. Time required for subjecting 50 L of the colloidal silica slurry E to circulating liquid passing through the first-stage filtration system, using a small diaphragm pump, to perform filtration apparently corresponding to 8 passes was 3.3 hours (average liquid passing quantity: 2.0 L/min). Further, time required for subjecting the colloidal silica slurry E to one pass filtration through the second-stage filtration system was 0.4 hours. Thus, total time required for the first-stage and second-stage filtrations was 3.7 hours (Table 2 shown below).

Substrates to be polished were polished through use of the polishing liquid compositions produced by the production processes of Example 10 and Comparative Examples 9-10 as described above, and the number of scratches and particles of the polished substrates were evaluated. Table 2 shows the evaluation results. The substrates to be polished, the polishing condition (polishing method), and the evaluation method are the same as those of Example 1.

TABLE 2

| | | | Example | Comparative Example | |
|---|---|---|---|---|---|
| | | | 10 | 9 | 10 |
| Raw silica | Kind | | D | D | E |
| dispersion | Amount of coarse particles | 10⁴ pieces/mL | 47.9 | 47.9 | 6.9 |
| | 0.45 μm filter liquid passing quantity | mL | 5 | 5 | 20 |
| Filtration | Filtration system | | One stage of depth filter + | Two stages of depth filter | Two stages of depth filter |
| | | | one stage of diatom aceous | (circulation) + | (circulation) + |
| | | | earth filter + | one stage of pleats filter | one stage of pleats filter |
| | | | one stage of pleats filter | | |
| | | | One pass filtration | Circulating filtration | Circulating filtration |
| | | | | (corresponding to 8 passes) | (corresponding to |
| | | | | | 8 passes) |
| | Filtration treatment time | Hr | 0.9 | 3.7 | 3.7 |
| Dispersion | Amount of coarse particles | 10⁴ pieces/mL | 2.2 | 4.0 | 2.9 |
| after | 0.45 μm filter liquid passing quantity | mL | 320 | 35 | 65 |
| filtration | | | | | |
| Polishing | Scratch | Lines/surface | 30 | 44 | 33 |
| evalution | particle | Pieces/surface | 275 | 464 | 276 |

Comparative Example 10 is a conventional process for producing a polishing liquid composition that includes filtering a silica slurry (slurry E), which was obtained by subjecting a general-purpose colloidal silica slurry (slurry D) to an additional treatment (for example, centrifugation), with a circulating filtration system of a depth filter. On the other hand, Example 10 is a process for producing a polishing liquid composition using a filtration system that includes a combination of a depth filter and a diatomaceous earth-including filter in place of the circulating filtration system of a depth filter of Comparative Example 10. As is apparent from the results of Table 2, according to the production process of Example 10, a polishing liquid composition of quality (reduction in amount of coarse particles, scratches, and particles) equal to or more than that of the polishing liquid composition produced by the conventional production process (Comparative Example 10) can be produced with good productivity. The production process of Example 10 can use the general-purpose colloidal silica slurry (slurry E) as it is without subjecting the slurry to an additional treatment (for example, centrifugation), and hence, can reduce cost and time, which leads to enhancement of productivity. As is apparent from the results of Table 2, when the general-purpose colloidal silica slurry (slurry D) is used in place of the silica slurry (slurry E) subjected to an additional treatment in the conventional production process (Comparative Example 10), the quality of a polishing composition to be produced is degraded greatly (Comparative Example 9). Further, the production process of Example 10 can use one pass filtration instead of circulating filtration of a depth filter (Comparative Examples 9-10), and hence, can reduce time required for producing a polishing liquid composition, which leads to enhancement of productivity.

### 3. Examples 11-13 and Comparative Example 11

Polishing liquid compositions were produced by the production process similar to that of Example 10, except for using depth filters having different histories of a filtration treatment amount as the depth filter of Example 10 (Examples 11-13). Further, a polishing liquid composition was produced by the production process similar to that of Example 10, except for not using a depth filter (Comparative Example 11). Substrates were polished through use of the respective polishing liquid compositions, and the surfaces of the substrates after polishing were evaluated. Unless otherwise described particularly, the methods for measuring various parameters described in the following Table 3 were the same as those of Example 1.

<Raw Silica Dispersion>

As a raw silica dispersion, a general-purpose colloidal silica slurry F (average primary-particle diameter: 24 nm, amount of coarse particles: 553,000 pieces/mL, silica particle concentration: 40% by weight, pH=9.9, produced by JGC Catalysts & Chemicals Co., Ltd.) was used.

### Production of Polishing Liquid Compositions of Examples 11-13

As a filtration system for obtaining filtered colloidal silica to be used in the polishing liquid compositions of Examples 11-13, a filtration system in which one depth filter in a first stage, one diatomaceous earth-including filter (cake filter) in a second stage, and a pleats filter in a third stage were arranged in series of three stages in this order was used. FIG. 1 shows a schematic view of the filtration system. The colloidal silica slurry F that was a raw silica dispersion was subjected to one pass filtration with the filtration system to obtain filtered colloidal silica. A polishing liquid composition was produced in the same way as in Example 1, using the obtained filtered colloidal silica. The depth filter, the diatomaceous earth-including filter, and the pleats filter used herein are the same as those of Example 10. Note that, depth filters having descending number of histories of a filtration treatment amount were used in the order of Examples 11, 12, and 13. The ability to remove coarse particles of the depth filter decreases as a use history (filtration treatment amount history) increases. That is, the number of coarse particles contained in the silica dispersion filtered with the first-stage depth filter increases in the order of Examples 11, 12, and 13 (Table 3 described below). The amount, which can be treated by the time when the second-stage diatomaceous earth filter is closed in the case of using these depth filters is measured, and the following Table 3 shows the results.

### Production of a Polishing Liquid Composition of Comparative Example 11

As a filtration system for obtaining filtered colloidal silica to be used in a polishing liquid composition of Comparative Example 11, a filtration system in which one diatomaceous earth-including filter in a first stage (cake filter) and one pleats filter in a second stage were arranged in series of two stages in this order was used. That is, the colloidal silica slurry F that was a raw silica dispersion was introduced into the first-stage cake filter to be subjected to one pass filtration without being filtered with the depth filter to obtain filtered colloidal silica. A polishing liquid composition was produced in the same way as in Example 1 through use of the obtained filtered colloidal silica. The diatomaceous earth-including filter and the pleats filter used herein are the same as those of Example 10. The amount that can be treated by the time when the first-stage cake filter is closed is measured, and the following Table 3 shows the results.

Substrates to be polished were polished with the polishing liquid compositions produced by the production processes of Examples 11-13 and Comparative Example 11 described above, and the number of scratches and particles on the polished substrates were evaluated. The following Table 3 shows the evaluation results. The substrates to be polished, the polishing condition (polishing method), and the evaluation method are the same as those of Example 1.

TABLE 3

| | | | | | | Comparative |
|---|---|---|---|---|---|---|
| | | | Example | | | Example |
| | | | 11 | 12 | 13 | 11 |
| Amount of coarse particles in silica dispersion after being | | 10⁴ pieces/mL | 2.8 | 6.9 | 10.6 | (55.3) |
| treated with first-stage depth filter | | | | | | Untreated |
| Amount that can be filtered by the time when second- | | L | 119 | 42 | 11 | 6 |
| stage diatomaceous earth-including filter is closed | | | | | | |
| Dispersion after | Amount of coarse particles | 10⁴ pieces/mL | 1.9 | 1.8 | 1.8 | 1.9 |
| filtration | 0.45 μm filter liquid passing quantity | mL | 115 | 120 | 112 | 112 |
| Polishing | Scratch | Lines/surface | 33 | 30 | 32 | 37 |
| evaluation | Particle | Pieces/surface | 271 | 278 | 299 | 285 |

As is understood from the comparison between the results of Examples 11-13 and that of Comparative Example 11 in Table 3, the life of the diatomaceous earth-including filter is extended due to the filtration through use of the depth filter. Further, it is understood that, as the amount of coarse particles to be removed by the depth filter is larger (that is, the amount of coarse particles in a silica dispersion introduced into the diatomaceous earth-including filter is smaller), the life of the diatomaceous earth-including filter is extended. For example, when the amount of coarse particles in the silica dispersion after a treatment with the first-stage depth filter reaches 10.0×10⁴ pieces/mL or less (Examples 11 and 12), the life of the diatomaceous earth-including filter is greatly extended to contribute to enhancement of productivity of a polishing liquid composition, compared with the case where the amount of coarse particles is 10.0×10⁴ pieces/mL or more (Example 13).

### INDUSTRIAL APPLICABILITY

A polishing liquid composition produced by the production process of the present invention can be used for, for example, the step of polishing a precision component substrate for high density or high integration.

The present invention relates to the following.

<1> A process for producing a polishing liquid composition, including the step of filtering a raw silica dispersion containing colloidal silica having a average primary-particle diameter of 1 to 100 nm with a filter including a filter aid, wherein the filter aid has an average pore diameter, as measured by a mercury intrusion method, of 0.1 to 3.5 μm.

<2> A process for producing a polishing liquid composition according to the above-mentioned <1>, wherein the filter aid is diatomaceous earth.

<3> A process for producing a polishing liquid composition according to the above-mentioned <1> or <2>, wherein an integrated pore volume of 0.5 μm or less of the filter aid, as measured by the mercury intrusion method, is 2.5 mL/g or more.

<4> A process for producing a polishing liquid composition according to any one of the above-mentioned <1> to <3>, wherein the filter aid has a BET specific surface area of 4.0 m²/g or more and an integrated pore volume of 0.15 μm or less, as measured by a nitrogen adsorption method, of 0.3 mL/g or more.

<5> A process for producing a polishing liquid composition according to the above-mentioned <1> to <4>, wherein a water permeability of the filter aid obtained by filtering water with the filter aid under a condition of 0.015 MPa is 5.0×10⁻¹⁴ m² or less.

<6> A process for producing a polishing liquid composition according to any one of the above-mentioned <1> to <5>, including the following Steps 1 and 2:

Step 1) filtering a raw silica dispersion containing colloidal silica having an average primary-particle diameter of 1 to 100 nm so that an amount of coarse particles having a particle diameter of 0.5 μm or more becomes 11.0×10⁴ pieces/mL or less; and

Step 2) filtering the silica dispersion obtained in the Step 1 with the filter including a filter aid having an average pore diameter, as measured by a mercury intrusion method, of 0.1 to 3.5 μm.

<7> A process for producing a polishing liquid composition according to the above-mentioned <6>, wherein, in the Step 1, the raw silica dispersion is filtered so that the amount of coarse particles becomes preferably 10.0×10⁴ pieces/mL or less, more preferably 7.0×10⁴ pieces/mL or less, still more preferably 6.0×10⁴ pieces/mL or less, still further preferably 5.0×10⁴ pieces/mL or less, still further preferably 4.0×10⁴ pieces or less, still further preferably 3.0×10⁴ pieces/mL or less.

<8> A process for producing a polishing liquid composition according to the above-mentioned <6> or <7>, wherein the filtering in the Step 1 is filtration using a depth filter.

<9> A process for producing a polishing liquid composition according to the above-mentioned <8>, wherein the depth filter has an opening diameter of 5.0 μm or less.

<10> A process for producing a polishing liquid composition according to the above-mentioned <8> or <9>, wherein the filtering in the Step 1 is multistage filtration using the depth filter.

<11> A process for producing a polishing liquid composition according to any one of the above-mentioned <6> to <10>, further including the following Step 3:

Step 3) filtering the silica dispersion obtained in the Step 2 with a pleats filter.

<12> A process for producing a polishing liquid composition according to the above-mentioned <11>, wherein the please filter has an opening diameter of 1.0 μm or less.

<13> A process for producing a polishing liquid composition according to any one of the above-mentioned <6> to <12>, wherein the filtering in the Steps 1 and 2 is performed through one pass.

<14> A process for producing a polishing liquid composition according to any one of the above-mentioned <1> to <13>, wherein an amount of coarse particles having a particle diameter of 0.5 μm or more in the raw silica dispersion is 20.0×10⁴ pieces/mL or more.

<15> A process for producing a polishing liquid composition according to any one of the above-mentioned <1> to <14>, wherein an amount of coarse particles having a particle diameter of 0.5 μm or more in the raw silica dispersion is 200.0×10⁴ pieces/mL or less.

<16> A process for producing a polishing liquid composition according to any one of the above-mentioned <1> to <15>, wherein a content of colloidal silica in the raw silica dispersion is 1 to 50% by weight.

<17> A process for producing a polishing liquid composition according to any one of the above-mentioned <1> to <16>, wherein a content of coarse particles having a particle diameter of 0.5 μm or more in a polishing liquid composition to be obtained is 0.5 to 10×10⁴ pieces/mL.

<18> A process for producing a polishing liquid composition according to any one of the above-mentioned <1> to <17>, wherein a content of the filter aid in the filter including a filter aid is 0.001 to 1 g/cm².

<19> A process for producing a polishing liquid composition according to any one of the above-mentioned <1> to <18>, wherein a differential pressure at a time of filtration with the filter including a filter aid is 0.01 to 10 MPa.

<20> A process for producing a polishing liquid composition according to any one of the above-mentioned <1> to <19>, wherein a filtration speed at a time of filtration with the filter including a filter aid is 0.1 to 30 L/(min·m²).

<21> A process for producing a polishing liquid composition according to any one of the above-mentioned <1> to <20>, wherein an average pore diameter of the filter aid, as measured by the mercury intrusion method, is preferably 0.1 to 3.0 μm, more preferably 0.1 to 2.7 μm, still more preferably 1.0 to 2.7 μm, still further preferably 2.0 to 2.7 μm, still further preferably 2.1 to 2.7 μm, still further preferably 2.2 to 2.6 μm, still further preferably 2.2 to 2.4 μm.

<22> A process for producing a polishing liquid composition according to any one of the above-mentioned <1> to <21>, wherein an integrated pore volume of 0.5 μm or less of the filter aid, as measured by the mercury intrusion method, is preferably 2.5 to 1,000 mL/g, more preferably 2.7 to 100 mL/g, still more preferably 3.0 to 50 mL/g, still further preferably 4.0 to 20 mL/g, still further preferably 4.5 to 10 mL/g, still further preferably 4.5 to 6 mL/g.

<23> A process for producing a polishing liquid composition according to any one of <1> to <22>, wherein a BET specific surface area of the filter aid is preferably 4.0 to 1,000.0 m²/g, more preferably 10.0 to 100.0 m²/g, still more preferably 15.0 to 50.0 m²/g, still further preferably 15.0 to 30.0 m²/g, still further preferably 18.0 to 30.0 m²/g, still further preferably 18.0 to 25.0 m²/g.

<24> A process for producing a polishing liquid composition according to any one of the above-mentioned <1> to <23>, wherein an integrated pore volume of 0.15 μm or less, as measured by a nitrogen adsorption method, is preferably 0.3 to 100.0 mL/g, more preferably 0.4 to 50.0 mL/g, still more preferably 0.6 to 10.0 mL/g, still further preferably 0.6 to 5.0 mL/g, still further preferably 0.6 to 2.0 mL/g, still further preferably 0.6 to 1.0 mL/g, still further preferably 0.6 to 0.7 mL/g.

<25> A process for producing a polishing liquid composition according to any one of the above-mentioned <1> to <24>, wherein a water permeability of the filter aid obtained by filtering water with the filter aid under a condition of 0.015 MPa is preferably 2.0×10⁻¹⁵ to 9.9×10⁻¹⁴ m², more preferably 5.0×10⁻¹⁵ to 5.0×10⁻¹⁴ m², still more preferably 9.9×10⁻¹⁵ to 3.0×10⁻¹⁴ m².

<26> A process for producing a polishing liquid composition according to any one of the above-mentioned <1> to <25>, wherein the Step 1 includes filtering a raw silica dispersion containing colloidal silica having an average primary-particle diameter of 1 to 100 nm so that an amount of coarse particles having a particle diameter of 0.5 μm or more becomes preferably 10.0×10⁴ pieces/mL or less, more preferably 7.0×10⁴ pieces/mL or less, still more preferably 6.0×10⁴ pieces/mL or less, still further preferably 5.0×10⁴ pieces/mL or less, still further preferably 4.0×10⁴ pieces/mL or less, still further preferably 3.0×10⁴ pieces/mL or less.

<27> A process for producing a polishing liquid composition according to any one of the above-mentioned <1> to <26>, wherein an amount of coarse particles having a particle diameter of 0.5 μm or more in the raw silica dispersion is preferably 20.0×10⁴ to 200.0×10⁴ pieces/mL, more preferably 20.0×10⁴ to 100.0×10⁴ pieces/mL, still more preferably 30.0×10⁴ to 100.0×10⁴ pieces/mL, still further preferably 34.0×10⁴ to 100.0×10⁴ pieces/mL, still further preferably 34.0×10⁴ to 70.0×10⁴ pieces/mL.

<28> A process for producing a polishing liquid composition according to any one of the above-mentioned <1> to <27>, wherein a content of coarse particles having a particle diameter of 0.5 μm or more in a polishing liquid composition to be obtained is preferably 0.5×10⁴ to 5×10⁴ pieces/mL, more preferably 0.5×10⁴ to 4×10⁴ pieces/mL, still more preferably 0.5×10⁴ to 3×10⁴ pieces/mL.

<29> A polishing liquid composition produced by the production method according to any one of the above-mentioned <1> to <28>.

<30> A polishing liquid composition according to the above-mentioned <29>, further containing an acid, an oxidizing agent, a water-soluble polymer having an anionic group, a heterocyclic aromatic compound, and an aliphatic amine compound or an alicylic amine compound.

<31> A process for producing a magnetic disk substrate, including: producing a polishing liquid composition by the production process according to any one of the above-mentioned <1> to <28>; and supplying the polishing liquid composition to a polishing surface of a substrate to be polished, bringing a polishing pad into contact with the polishing surface, and moving the polishing pad and/or the substrate to be polished to polish the polishing surface.

1. A process for producing a polishing liquid composition, comprising the step of filtering a raw silica dispersion containing colloidal silica having an average primary-particle diameter of 1 to 100 nm with a filter including a filter aid, wherein the filter aid has an average pore diameter, as measured by a mercury intrusion method, of 0.1 to 3.5 μm.

2. A process for producing a polishing liquid composition according to claim 1, wherein the filter aid is diatomaceous earth.

3. A process for producing a polishing liquid composition according to claim 1, wherein an integrated pore volume of 0.5 μm or less of the filter aid, as measured by the mercury intrusion method, is 2.5 mL/g or more.

4. A process for producing a polishing liquid composition according to claim 1, wherein the filter aid has a BET specific surface area of 4.0 m²/g or more and an integrated pore volume of 0.15 μm or less, as measured by a nitrogen adsorption method, of 0.3 mL/g or more.

5. A process for producing a polishing liquid composition according to claim 1, wherein a water permeability of the filter aid obtained by filtering water with the filter aid under a condition of 0.015 MPa is 5.0×10⁻¹⁴ m² or less.

6. A process for producing a polishing liquid composition according to claim 1, comprising the following Steps 1 and 2:
Step 1) filtering a raw silica dispersion containing colloidal silica having an average primary-particle diameter of 1 to 100 nm so that an amount of coarse particles having a particle diameter of 0.5 μm or more becomes 11.0×10⁴ pieces/mL or less; and
Step 2) filtering the silica dispersion obtained in the Step 1 with a filter including a filter aid having an average pore diameter, as measured by a mercury intrusion method, of 0.1 to 3.5 μm.

7. A process for producing a polishing liquid composition according to claim 6, wherein, in the Step 1, the raw silica dispersion is filtered so that the amount of coarse particles becomes 7.0×10⁴ pieces/mL or less.

8. A process for producing a polishing liquid composition according to claim 6, wherein the filtering in the Step 1 is filtration using a depth filter.

9. A process for producing a polishing liquid composition according to claim 8, wherein the depth filter has an opening diameter of 5.0 μm or less.

10. A process for producing a polishing liquid composition according to claim 8, wherein the filtering in the Step 1 is multistage filtration using the depth filter.

11. A process for producing a polishing liquid composition according to claim 6, further comprising the following Step 3:
Step 3) filtering the silica dispersion obtained in the Step 2 with a pleats filter.

12. A process for producing a polishing liquid composition according to claim 11, wherein the pleats filter has an opening diameter of 1.0 μm or less.

13. A process for producing a polishing liquid composition according to claim 6, wherein the filtering in the Steps 1 and 2 is performed through one pass.

14. A process for producing a polishing liquid composition according to claim 1, wherein an amount of coarse particles having a particle diameter of 0.5 μm or more in the raw silica dispersion is 20.0×10⁴ pieces/mL or more.

15. A process for producing a polishing liquid composition according to claim 1, wherein an amount of coarse particles having a particle diameter of 0.5 μm or more in the raw silica dispersion is 200.0×10⁴ pieces/mL or less.

16. A process for producing a polishing liquid composition according to claim 1, wherein a content of colloidal silica in the raw silica dispersion is 1 to 50% by weight.

17. A process for producing a polishing liquid composition according to claim 1, wherein a content of coarse particles having a particle diameter of 0.5 μM or more in a polishing liquid composition to be obtained is 0.5×10⁴ to 10×10⁴ pieces/mL.

18. A process for producing a polishing liquid composition according to claim 1, wherein a content of the filter aid in the filter including a filter aid is 0.001 to 1 g/cm².

19. A process for producing a polishing liquid composition according to claim 1, wherein a differential pressure at a time of filtration with the filter including a filter aid is 0.01 to 10 MPa.

20. A process for producing a polishing liquid composition according to claim 1, wherein a filtration speed at a time of filtration with the filter including a filter aid is 0.1 to 30 L/(min·m²).

21. A polishing liquid composition produced by the production process according to claim 1.

22. A polishing liquid composition according to claim 21, further comprising an acid, an oxidizing agent, a water-soluble polymer having an anionic group, a heterocyclic aromatic compound, and an aliphatic amine compound or an alicylic amine compound.

23. A process for producing a magnetic disk substrate, comprising: producing a polishing liquid composition by the production process according to claim 1; and
supplying the polishing liquid composition to a polishing surface of a substrate to be polished, bringing a polishing pad into contact with the polishing surface, and moving the polishing pad and/or the substrate to be polished to polish the polishing surface.
